(19) United States
(12) Patent Application Publication
(10) Pub. No.: US 2026/0323396 A1
(43) Pub. Date: Oct. 15, 2026

(54) METHOD FOR MODIFYING SESSION, APPARATUS FOR MODIFYING SESSION, AND COMMUNICATION DEVICE

(71) Applicant: VIVO MOBILE COMMUNICATION CO., LTD., Guangdong (CN)

(72) Inventors: Yizhong ZHANG, Guangdong (CN); Yanchao KANG, Guangdong (CN); Hui WANG, Guangdong (CN)

(73) Assignee: VIVO MOBILE COMMUNICATION CO., LTD., Guangdong (CN)

(21) Appl. No.: 19/467,201

(22) Filed: Feb. 2, 2026

Related U.S. Application Data
(63) Continuation of application No. PCT/CN2024/108083, filed on Jul. 29, 2024.

(30) Foreign Application Priority Data
Aug. 2, 2023 (CN) 202310968433.5

(51) Int. Cl. H04W 28/18; H04W 28/24; H04W 72/512

(52) U.S. Cl. CPC H04W 28/18; H04W 28/24; H04W 72/512

(57) ABSTRACT

Disclosed are a method for modifying a session, an apparatus for modifying a session, and a communication device. The method for modifying a session according to embodiments of the present disclosure is applied to a first network side device, and includes obtaining first information by the first network side device; and modifying, by the first network side device, a first session according to the first information. The first session is used for carrying service data of a first service of a terminal. The first service includes at least one of an artificial intelligence AI service and a computing service. The first information includes at least one of the following: requirement description information of the first service; service resource configuration information; and a first request message. The first request message is used for requesting modification of the first session.

### CROSS-REFERENCE TO RELATED APPLICATIONS

The present disclosure is a continuation application of PCT International Application No. PCT/CN2024/108083 filed on Jul. 29, 2024, which claims priority to Chinese Patent Application No. 202310968433.5 filed on Aug. 2, 2023, which is incorporated herein by reference in its entirety.

### TECHNICAL FIELD

The present disclosure belongs to the technical field of communication, and particularly relates to a method for modifying a session, an apparatus for modifying a session, and a communication device.

### BACKGROUND

At present, artificial intelligence (AI) has been widely used in various fields. Integrating the AI into communication networks to significantly improve technical indicators such as a throughput, a delay, and a user capacity is an important optimization direction of future communication networks.

In related technologies, a network data analytics function (NWDAF) has been introduced to perform some intelligent analysis. Specifically, the NWDAF has a function of intelligent AI analysis or computation. The NWDAF analyzes or computes some results by collecting some data and using a built-in algorithm and analysis capability, and supplies the results to a network element of a core network of a communication system of the 5^{th} generation (5G) or beyond 5G for some operation optimization or statistical analysis. However, existing core networks only use NWDAF network elements to execute some operation optimization related to AI or computation, and cannot provide AI as a service for user equipment (UE) or the third party.

Thus, how to perform introduction or modification in a session to support AI or a computing service has become a problem to be urgently solved.

### SUMMARY

Embodiments of the present disclosure provide a method for modifying a session, an apparatus for modifying a session, and a communication device.

A first aspect provides a method for modifying a session. The method includes: obtaining first information by a first network side device; and
modifying, by the first network side device, a first session according to the first information. The first session is used for carrying service data of a first service of a terminal. The first service includes at least one of an artificial intelligence AI service and a computing service.

The first information includes at least one of the following:
requirement description information of the first service;
service resource configuration information; and
a first request message, where the first request message is used for requesting modification of the first session.

A second aspect provides a method for modifying a session. The method includes:
obtaining fourth information by a second network side device; and
modifying, by the second network side device, a communication bearer related to a first session according to the fourth information. The first session is used for carrying service data of a first service. The first service includes at least one of an artificial intelligence AI service and a computing service.

The fourth information includes at least one of the following:
fifth information, where the fifth information includes session information of the modified first session or a second notification message from a first network side device, and the second notification message is used for indicating modification of the communication bearer or a communication policy related to the first session; and
a fourth notification message from a third network side device, where the fourth notification message is used for notifying a second network side device of modification of the communication policy related to the first session.

A third aspect provides a method for modifying a session. The method includes:
receiving a fifth notification message by a third network side device, where the fifth notification message is used for notifying the third network side device of modification of a service policy related to a first session or modification of a communication policy related to the first session; and the first session is used for carrying service data of a first service, and the first service includes at least one of an artificial intelligence AI service and a computing service; and
executing, by the third network side device according to the fifth notification message, at least one of the following steps:
sending a first notification message to a first network side device, where the first notification message is used for notifying the first network side device of modification of the first session; and
sending a fourth notification message to a second network side device, where the fourth notification message is used for notifying the second network side device of modification of the communication policy related to the first session.

A fourth aspect provides an apparatus for modifying a session. The apparatus includes:
a first obtainment module, configured to obtain first information; and
a first modification module, configured to modify a first session according to the first information, where the first session is used for carrying service data of a first service of a terminal, and the first service includes at least one of an artificial intelligence AI service and a computing service.

The first information includes at least one of the following:
requirement description information of the first service;
service resource configuration information; and
a first request message, where the first request message is used for requesting modification of the first session.

A fifth aspect provides an apparatus for modifying a session. The apparatus includes:
a second obtainment module, configured to obtain fourth information; and
a second modification module, configured to modify a communication bearer related to a first session according to the fourth information, where the first session is used for carrying service data of a first service, and the first service includes at least one of an artificial intelligence AI service and a computing service.

The fourth information includes at least one of the following:
fifth information, where the fifth information includes session information of the modified first session or a second notification message from a first network side device, and the second notification message is used for indicating modification of the communication bearer or a communication policy related to the first session; and
a fourth notification message from a third network side device, where the fourth notification message is used for notifying a second network side device of modification of the communication policy related to the first session.

A sixth aspect provides an apparatus for modifying a session. The apparatus includes:
a first reception module, configured to receive a fifth notification message, where the fifth notification message is used for notifying a third network side device of modification of a service policy related to a first session, or modification of a communication policy related to the first session; and the first session is used for carrying service data of a first service, and the first service includes at least one of an artificial intelligence AI service and a computing service; and
an execution module, configured to execute, according to the fifth notification message, at least one of the following steps:
sending a first notification message to a first network side device, where the first notification message is used for notifying the first network side device of modification of the first session; and
sending a fourth notification message to a second network side device, where the fourth notification message is used for notifying the second network side device of modification of the communication policy related to the first session.

A seventh aspect provides a network side device. The network side device includes a processor and a memory.

In a case that the network side device is a first network side device, the memory stores a program or an instruction runnable on the processor. When the program or the instruction is executed by the processor, steps of the method according to the first aspect are implemented.

In a case that the network side device is a second network side device, the memory stores a program or an instruction runnable on the processor. When the program or the instruction is executed by the processor, steps of the method according to the second aspect are implemented.

In a case that the network side device is a third network side device, the memory stores a program or an instruction runnable on the processor. When the program or the instruction is executed by the processor, steps of the method according to the third aspect are implemented.

An eighth aspect provides a network side device. The network side device includes a processor and a communication interface.

In a case that the network side device is a first network side device, the communication interface is configured to obtain first information; and the processor is configured to modify a first session according to the first information. The first session is used for carrying service data of a first service of a terminal. The first service includes at least one of an artificial intelligence AI service and a computing service.

The first information includes at least one of the following:
requirement description information of the first service;
service resource configuration information; and
a first request message, where the first request message is used for requesting modification of the first session.

In a case that the network side device is a second network side device, the communication interface is configured to obtain fourth information; and the processor is configured to modify a communication bearer related to a first session according to the fourth information. The first session is used for carrying service data of a first service. The first service includes at least one of an artificial intelligence AI service and a computing service.

The fourth information includes at least one of the following:
fifth information, where the fifth information includes session information of the modified first session or a second notification message from a first network side device, and in the second notification message is used for indicating modification of the communication bearer or a communication policy related to the first session; and
a fourth notification message from a third network side device, where the fourth notification message is used for notifying the second network side device of modification of the communication policy related to the first session.

In a case that the network side device is the third network side device, the communication interface is configured to receive a fifth notification message. The fifth notification message is used for notifying the third network side device of modification of a service policy related to the first session or modification of the communication policy related to the first session. The first session is used for carrying service data of a first service. The first service includes at least one of an artificial intelligence AI service and a computing service. The communication interface is further configured to execute, according to the fifth notification message, at least one of the following steps:
sending a first notification message to a first network side device, where the first notification message is used for notifying the first network side device of modification of the first session; and
sending a fourth notification message to a second network side device, where the fourth notification message is used for notifying the second network side device of modification of the communication policy related to the first session.

A ninth aspect provides a readable storage medium. The readable storage medium stores a program or an instruction. When the program or the instruction is executed by a processor, steps of the method according to the first aspect, the second aspect or the third aspect are implemented.

A tenth aspect provides a communication system. The communication system includes a first network side device, or includes a first network side device and at least one of a second network side device and a third network side device. The first network side device may be configured to execute steps of the method according to the first aspect. The second network side device may be configured to execute steps of the method according to the second aspect. The third network side device may be configured to execute steps of the method according to the third aspect.

An eleventh aspect provides a chip. The chip includes a processor and a communication interface. The communication interface is coupled to the processor. The processor is configured to run a program or an instruction, such that the method according to the first aspect, the second aspect or the third aspect is implemented.

A twelfth aspect provides a computer program/program product. The computer program/program product is stored in a storage medium. The computer program/program product is executed by at least one processor, such that steps of the method for modifying a session according to the first aspect, the second aspect or the third aspect are implemented.

### BRIEF DESCRIPTION OF THE DRAWINGS

FIG. 1 is a schematic structural diagram of a wireless communication system to which an embodiment of the present disclosure can be applied;

FIG. 2 is a first flowchart of a method for modifying a session according to an embodiment of the present disclosure;

FIG. 3 is a first schematic interaction diagram of a session modification process according to an embodiment of the present disclosure;

FIG. 4 is a second schematic interaction diagram of a session modification process according to an embodiment of the present disclosure;

FIG. 5 is a third schematic interaction diagram of a session modification process according to an embodiment of the present disclosure;

FIG. 6 is a fourth schematic interaction diagram of a session modification process according to an embodiment of the present disclosure;

FIG. 7 is a fifth schematic interaction diagram of a session modification process according to an embodiment of the present disclosure;

FIG. 8 is a second flowchart of a method for modifying a session according to an embodiment of the present disclosure;

FIG. 9 is a third flowchart of a method for modifying a session according to an embodiment of the present disclosure;

FIG. 10 is a first schematic structural diagram of an apparatus for modifying a session according to an embodiment of the present disclosure;

FIG. 11 is a second schematic structural diagram of an apparatus for modifying a session according to an embodiment of the present disclosure;

FIG. 12 is a third schematic structural diagram of an apparatus for modifying a session according to an embodiment of the present disclosure;

FIG. 13 is a schematic structural diagram of a communication device according to an embodiment of the present disclosure; and

FIG. 14 is a schematic structural diagram of a network side device according to an embodiment of the present disclosure.

### DETAILED DESCRIPTION

Technical solutions in embodiments of the present disclosure will be clearly described below with reference to accompanying drawings in the embodiments of the present disclosure. Obviously, the embodiments described are some embodiments rather than all embodiments of the present disclosure. Based on the embodiments of the present disclosure, all other embodiments obtained by those of ordinary skill in the art should fall within the protection scope of the present disclosure.

The terms such as “first” and “second” in the present disclosure are used for distinguishing between similar objects and are not intended to describe a specific order or sequence. It should be understood that terms used in this way can be interchanged under appropriate circumstances, such that the embodiments of the present disclosure can be implemented in an order other than orders illustrated or described herein. In addition, the objects distinguished by “first” or “second” are generally objects of a same type, and a quantity of objects is not limited. For example, a quantity of first objects may be one or more. In addition, “or” in the present disclosure indicates at least one of connected objects. For example, “A or B” covers three solutions, that is, solution one including A and excluding B; solution two including B and excluding A; and solution three including A and B. The character “/” generally indicates an “or” relationship between two associated context objects.

The term “indication” in the description may be one direct indication (or an explicit indication) or one indirect indication (or an implicit indication). The direct indication may be understood as that a sender clearly informs a receiver of specific information, a to-be-executed operation, or a request result in the sent indication. The indirect indication may be understood as that a receiver determines corresponding information according to an indication sent by a sender, or performs determination and determines a to-be-executed operation or a request result according to a determination result.

It is worth pointing out that the technology described in the embodiments of the present disclosure is not limited to a long term evolution (LTE)/LTE-advanced (LTE-A) system, and may alternatively be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), or other systems. The terms “system” and “network” in the embodiments of the present disclosure are generally used interchangeably, and the described technology can be applied to the systems and radio technologies described above, or other systems and radio technologies. The following description describes a new radio (NR) system for illustration. NR terms are used in most of the following description, and the technologies can be applied to systems other than the NR system, such as a 6^{th} generation (6G) communication system.

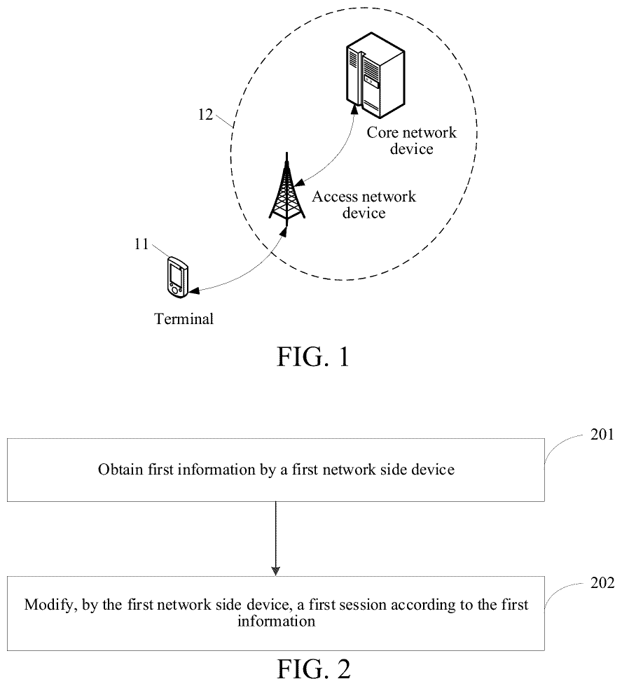

FIG. 1 shows a block diagram of a wireless communication system to which an embodiment of the present disclosure can be applied. The wireless communication system includes a terminal 11 and a network side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile Internet device (MID), augmented reality (AR), a virtual reality (VR) device, a robot, a wearable device, a flight vehicle, vehicle user equipment (VUE), a ship-borne device, pedestrian user equipment (PUE), a smart home appliance (a home device having a wireless communication function, such as a refrigerator, a television, a washing machine, or furniture), and terminal side devices such as a game machine, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, a smart ankle chain, etc.), a smart wrist strap, a smart garment, etc. The vehicle user equipment may alternatively be referred to as an in-vehicle terminal, an in-vehicle controller, an in-vehicle module, an in-vehicle component, an in-vehicle chip, an in-vehicle unit, etc. It should be noted that a specific type of the terminal 11 is not limited by the embodiment of the present disclosure. The network side device 12 may include an access network device or a core network device. The access network device may alternatively be referred to as a radio access network (RAN) device, a radio access network function, or a radio access network unit. The access network device may include a base station, a wireless local area network (WLAN) access point (AP), a wireless fidelity (WiFi) node, etc. The base station may be referred to as a node B (NB), an evolved node B (eNB), a next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission reception point (TRP), or any other suitable term in the art, as long as same technical effects are achieved. The base station is not limited to a particular technical vocabulary. It should be noted that, in the embodiment of the present disclosure, only the base station in the NR system is introduced as an example, and a specific type of the base station is not limited.

The core network device may include, but is not limited to, at least one of the following: a core network node, a core network function, a location management function (LMF), a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), etc. It should be noted that, in the embodiment of the present disclosure, only a core network device in an NR system is described as an example, and a specific type of the core network device is not limited.

In related technologies, an NWDAF has been introduced to perform some intelligent analysis. Specifically, the NWDAF has a function of intelligent AI analysis. The NWDAF analyzes some results by collecting some data and using a built-in algorithm and analysis capability, and supplies the results to a network element of a core network of a communication system of the 5th generation (5G) for some operation optimization or statistical analysis. However, the NWDAF fails to provide an AI service for UE.

In the embodiment of the present disclosure, an AI session is established between an AI resource node and the UE, such that the AI resource node provides a service for the UE through the AI session. That is, AI is provided for the UE or a third party as a service. After the AI session is established, a network side device or a third party node may modify the AI session.

For convenience of understanding of a method for modifying a session according to the embodiment of the present disclosure, the following nouns or terms in the embodiments of the present disclosure will be described below.

1) A first service may alternatively be referred to as an AI service or a computing service. That is, AI is provided for a terminal as a service. For convenience of description, the embodiment of the present disclosure performs illustration with the AI service as the first service as an example, which does not constitute a specific limitation herein.

2) A first session is a network resource allocated by a network side to the first service. When the first service is the AI service, the first session may alternatively be referred to as an AI session, and is a process in which UE is in communication with an AI resource node. After the AI session is established, one data transmission channel between the UE and the AI resource node is established. Thus, if the UE needs to use the AI service (for example, AI data transmission), one AI session needs to be established first. In other words, the AI session is an AI resource established between the UE and the AI resource node. In addition, the AI session may alternatively be referred to as an AI service connection or an AI connection in some cases.

3) A first request message is used for requesting modification of the first session. For example, in a case that the first session is the AI session, the first request message may be an AI session modification request message, an AI service bearer modification request message, or an AI bearer modification request message.

It should be noted that, in some implementations, the AI session has a communication requirement (for example, quality of service (QoS)). However, in an AI session modification process, whether to modify an AI bearer or a communication bearer is not limited. That is, in an AI session modification process, only an AI resource, only a communication resource, or both the AI resource and the communication resource may be modified.

4) Logical functions of all functional network elements in the embodiment of the present disclosure are shown in the following Table 1:

TABLE 1

| Network | | |
|---|---|---|
| element name | Function description | Example |
| Non access | AN signaling interface (N2) endpoint, and NAS | NAS interface |
| stratum (NAS) | (N1) signaling (MM message) endpoint | function, AMF |
| interface | Responsible for cipher and integrity protection | |
| function | of an NAS message, and responsible for | |
| | functions such as registration, access, mobility | |
| | management, authentication, and short | |
| | messages | |
| Second | Endpoint of a session management (SM) | Communication |
| network side | message of an NAS message | management |
| device | Session establishment, modification, and | function, |
| | release | SMF |
| | UE Internet protocol (IP) address allocation | |
| | and management | |
| | UPF selection and control | |
| | Charging data collection and charging interface | |
| | supporting | |
| | Determination of a session and service | |
| | continuity (SSC) mode of one session | |
| | Downlink data indication | |
| Communication | Anchor point (when applicable) used for intra- | Communication |
| resource node | radio access technology (RAT)/inter-RATs | resource node, |
| | mobility; session point between an external | UPF |
| | protocol data unit (PDU) and a data network | |
| | interconnection; and packet routing and | |
| | forwarding | |
| | Data packet inspection; and implementation of | |
| | user plane policy rules, such as gating, | |
| | redirection, and traffic diversion | |
| Third network | Application and service data flow detection, and | Policy charging |
| side device | generation and provisioning of policies (such as | function, PCF |
| | a UE policy and a session policy) | |
| First network | Used for service management and service | AI service |
| function | identity parsing, and specifically, conversion | management function, |
| | of an external AI service request into an | external service |
| | internal AI resource management function and/ | management function, |
| | or a communication resource management process; | service management |
| | and determination of a required AI resource by | function, and |
| | considering an AI service type and a QoS | computing power |
| | requirement of an AI service | service management |
| | | function |
| Second | Used for model management, and specifically, | AI model management |
| network | determination of a suitable model according | function, and model |
| function | to an external model request | management function |
| Third network | Used for service resource management, and | AI resource |
| function | specifically, allocation, update, and release | management function, |
| | of an Al/computing power resource as required; | resource management |
| | and state update and maintenance of an | function, and |
| | AI/computing power resource node (AI RF) | computing power |
| | | resource management |
| | | function |
| First resource | Configured to perform service processing and | AI resource node, |
| node | service policy rule implementation, and | resource node, |
| | specifically, computation (a user plane | computing power |
| | execution process) of an AI service according | resource node, and |
| | to a command of an AI resource management | service resource node |
| | function; and updating of an AI resource state | |
| | to an AI resource management function | |
| Fourth network | Used for data management, including data | Data plane |
| function | source determination according to a data | management function |
| | request | |
| Data source | Configured to generate, store, and forward data | Data source |
| First | Configured to perform external service | Application server |
| communication | processing, and specifically, process and feed | (AS), application |
| device | back data forwarded by a resource node | function (AF), and |
| | | terminal |

5) A first network side device may include a network element of a logical function related to the AI service. For example, the first network side device includes at least one of an AI service management function, an AI model management function, an AI resource management function, an AI resource node, and a data plane management function.

It should be noted that the embodiment of the present disclosure performs description with a logical function of a network element as a main body as an example, and does not limit whether at least two functional network elements are combined. For example, whether the AI service management function and the AI resource node are the same function node or different function nodes is not limited. Further, for example, whether the AI service management function and a communication management function are the same function node or different function nodes is not limited. If network elements of two different logical functions are combined, an interaction process between the two logical functions is an internal process of the function node, and no corresponding step may be executed. For convenience of description, the embodiment of the present disclosure generally performs illustration with a case of separately arranging network elements of logical functions as an example, which does not constitute a specific limitation herein.

6) AI service data refers to data carried in an AI session. In some implementations, the AI session may be transmitted through a communication bearer. That is, user plane data of the AI session is transmitted (through a UPF) to the AI resource node for processing through a transmission channel of an existing communication bearer.

For convenience of description, the embodiment of the present disclosure generally performs illustration with a protocol data unit (PDU) session as the communication bearer as an example. For example, the AI session may be transmitted through a data radio bearer (DRB) of the PDU session.

The PDU session refers to one process of communication between UE and a data network (DN). After the PDU session is established, one data transmission channel between the UE and the DN is established. Thus, in related technologies, if the UE needs to perform data transmission with an application, one PDU session needs to be established first. In other words, the PDU session is a communication resource established between the UE and the application in a 5G network.

In related technologies, a PDU session establishment flow is briefly described as follows:

The UE initiates a PDU session establishment request to the network (which is sent to an SMF via an AMF). The UE allocates a PDU session identity ID and reports the PDU session identity to the network. The SMF allocates a corresponding transmission resource (communication resource) to the PDU session of the UE, which includes the steps that a user plane node UPF is selected, and establishment of a user plane is triggered. After the user plane is established, the UE may perform data transmission through the user plane corresponding to the established PDU session.

In related technologies, a PDU session modification flow is briefly described as follows:

The UE initiates a PDU session modification request to the network (which is sent to the SMF via the AMF). The UE carries information such as a PDU session identity (ID), a requested quality of service rule (QoS rule), and a requested quality of service flow description (QoS Flow description). The SMF authorizes and modifies a corresponding PDU session based on a request of the UE.

7) An AI session ID is used for identifying the AI session. In some implementations, the AI session ID is allocated by the UE during establishment of the AI session and is sent to the network. In some implementations, the AI session ID and the PDU session ID have an association, and for example, a one-to-one mapping relationship or a many-to-one mapping relationship. The UE determines the mapping relationship and then sends the mapping relationship to the network when the AI session is established. In a case that a plurality of AI session IDs are mapped to a same PDU session ID, a plurality of AI sessions may use a same PDU session for transmission. That is, the plurality of AI session IDs correspond to the same PDU session ID.

8) A first modification notification message is used for notifying the first network side device of modification of a service policy related to the first session, so as to trigger modification of notification messages of the first session by the first network side device. The notification messages specifically include a first notification message and a third notification message. The first notification message is sent by a third network side device, and the third notification message is sent by a second network side device.

9) A second modification notification message is used for notifying the second network side device of modification of a communication policy related to the first session, so as to trigger modification of notification messages of a communication bearer related to the first session by the second network side device. The notification messages specifically include a second notification message and a fourth notification message. The second notification message is sent by the first network side device, and the fourth notification message is sent by the third network side device.

10) A first modification notification message acknowledgement (ACK) is a response message of the first modification notification message, and specifically includes a first response message corresponding to the first notification message and a third response message corresponding to the third notification message.

11) A second modification notification message ACK is a response message of the second modification notification message, and specifically includes a second response message corresponding to the second notification message and a fourth response message corresponding to the fourth notification message.

A method for modifying a session, an apparatus for modifying a session, and a communication device according to the embodiments of the present disclosure will be described in detail below through some embodiments and their application scenes with reference to the accompanying drawings.

With reference to FIG. 2, an execution body of the method for modifying a session according to the embodiment of the present disclosure may be a first network side device. The first network side device may have a logical function related to an AI service, and for example, at least one of an AI service management function, an AI model management function, an AI resource management function, and a data plane management function. Or, the first network side device is an AI resource node, and is not specifically limited herein.

As shown in FIG. 2, the method for modifying a session may include the following steps:

Step 201, the first network side device obtains first information.

The first information includes at least one of the following:
requirement description information of a first service;
service resource configuration information; and
a first request message, where the first request message is used for requesting modification of a first session.

Step 202, the first network side device modifies the first session according to the first information. The first session is used for carrying service data of the first service of a terminal. The first service includes at least one of an artificial intelligence AI service and a computing service.

For convenience of description, the embodiment of the present disclosure generally performs illustration with the AI service as the first service as an example. In this case, the first session may be an AI session, and the first request message may be AI signaling or AI-related signaling.

Optionally, the first session satisfies at least one of the following:
the first session is a bearer between the terminal and a first resource node (for example, the AI resource node);
the first session has a first identity, for example, an AI session ID, used for uniquely identifying the first session;
the first session has at least one of a dedicated data network name (DNN) and single network slice selection assistance information (S-NSSAI); and
the first session has a quality of service QoS assurance between the terminal and the first resource node.

The first resource node includes a network function for processing the first service. The processing includes processing types such as forwarding, caching, computing, and discarding. Contents of the processing are the AI service and/or the computing service, and for example, processing an AI policy rule, performing computation (a user plane execution process) of the AI service according to a command of the AI resource management function, and performing updating of an AI resource state to the AI resource management function.

In some implementations, the requirement description information of the first service may be referred to as requirement description information of the AI service. The requirement description information of the AI service may be used for describing information related to an AI service to be modified. For example, the requirement description information of the first service includes at least one of the following:
an identity of the first service, and for example, an inference service (specifically, such as an environment reconstruction service and a facial identification service) or a training service;
a quality of experience (QoE) requirement of the first service;
quality of service QoS information of the first service, such as an AI service processing delay, AI service processing accuracy, an AI service computational load, and a data processing scale;
model information of the first service, such as a model identity, model precision, and a model downloading address; and
first indication information, where the first indication information is used for indicating whether interaction with a target network function is needed.

Optionally, the target network function may include at least one of a second network function, a third network function, a fourth network function, and the first resource node. The second network function is a model management function or the AI model management function. The third network function is the AI resource management function, a resource management function, or a computing power resource management function. The fourth network function is the data plane management function.

In the implementation, based on the requirement description information of the AI service, the first network side device may determine the AI session to be modified and information of the AI session to be modified, and for example, modify at least one of information such as a data source, a model, an AI bearer, an AI resource, and an AI policy of the AI session.

In some implementations, the service resource configuration information includes at least one of the following:
data source information of the first service, and for example, data source information of the AI service;
service resource information of the first service, and for example, AI resource information;
detection information of the first service, and for example, AI service detection information;
a processing rule of the first service, and for example, an AI service processing rule; and
AS address information of the first service, and for example, AS address information of the AI service.

The AI service detection information is used for detecting or identifying AI service traffic reaching the AI resource node.

Optionally, the AI service detection information includes at least one of the following: source interface information (used for indicating information of a sender of a traffic source of the AI service), a terminal IP address (used for indicating IP address information of the terminal), network slice information, transmission tunnel information (for example, communication resource tunnel information, or AI resource tunnel information), a packet filter group (used for identifying each AI service traffic data packet), an application identity (used for indicating application information for generating the AI service traffic), QoS flow information (for example, QoS flow identity information), session indication information of an Ethernet type, a fully qualified domain name (FQDN) filter used for domain names system (DNS) query, and protocol information (such as protocol description information, a protocol name, and a protocol identity).

The AI service processing rule is used for determining a processing rule of the AI service traffic reaching the AI resource node.

Optionally, the processing includes at least one of the following: forward, duplicate, drop, buffer, and compute.

In some other implementations, the AI service processing rule includes at least one of the following: network slice information, target interface information (used for indicating information of a target of the traffic source of the AI service), rule information (used for indicating which processing operation is performed by the AI service traffic data packet), and identity information (the identity information may identify one processing operation or rule information).

In some implementations, the first information may include the first request message. For example, a first communication device (for example, the terminal or a third-party application server) may send the first request message to the first network side device to request modification of the first session by the first network side device.

Optionally, the first request message includes at least one of the following:
the requirement description information of the first service;
second information, where the second information includes information of a communication resource related to the first session; and
third information, where the third information includes information of the first session.

In some implementations, the second information may be PDU session information, and is used for indicating allocation of a communication resource corresponding to the AI session by a network. The second information includes a PDU session ID, a PDU session type, QoS information (such as a QoS flow identity, a QoS rule, and QoS flow description information), a DNN, and S-NSSAI.

In some implementations, the third information may be AI session information, is used for describing one AI session, and includes an AI session ID, an AI session type, a DNN related to the AI session, a slice related to the AI session, and QoS information (such as a QoS flow identity, a QoS rule, and QoS flow description information) related to the AI session.

In some implementations, the first network side device includes at least one of the following:
a first network function, where the first network function is used for managing the first service, and for example, the first network function is the AI service management function;
a second network function, where the second network function is used for managing a model, and for example, the second network function is the AI model management function;
a third network function, where the third network function is used for managing a service resource, and for example, the third network function is the AI resource management function;
the first resource node, and for example, the AI resource node; and
a fourth network function, where the fourth network function is used for executing data management, and for example, the fourth network function is the data plane management function.

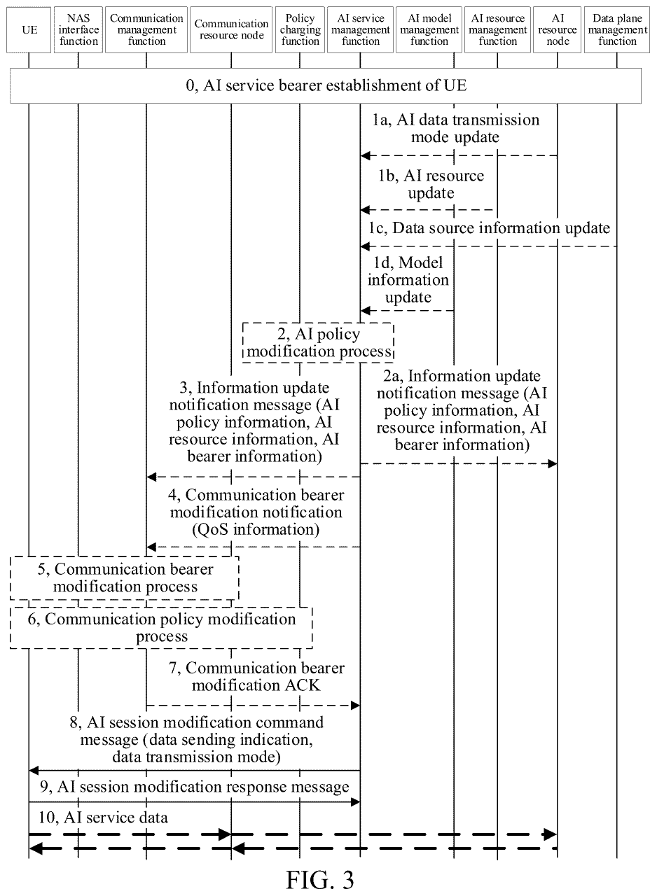

In one implementation, the first network side device may modify the first session based on its own requirement. For example, as shown in step 1a to step 1d in FIG. 3, at least one of the data plane management function, the AI resource node, the AI model management function, and the AI resource management function may execute corresponding modification based on its own requirement, and send a modified content to the AI service management function.

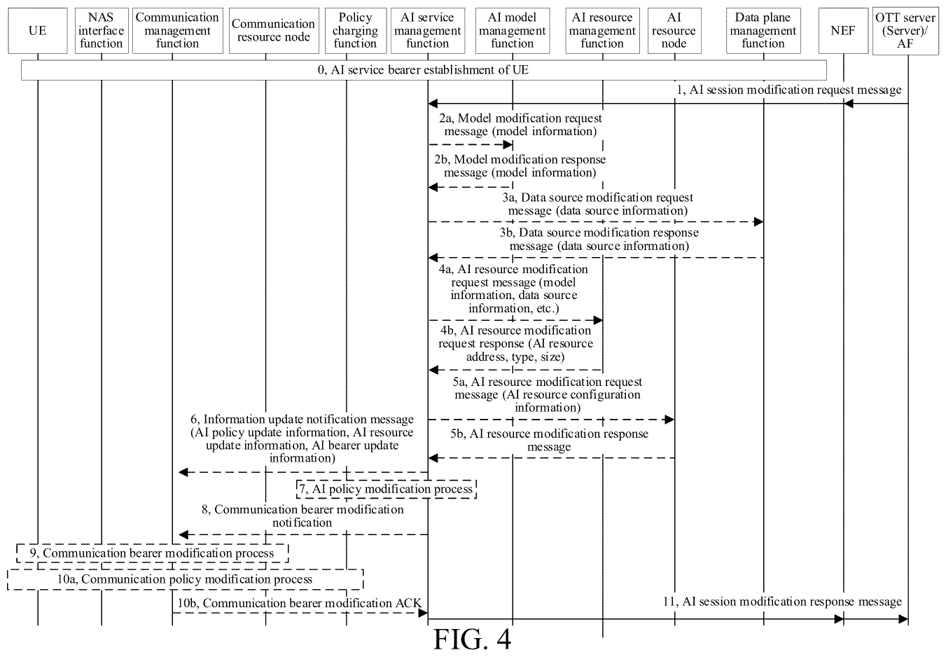

In another implementation, the first network side device modifies the first session according to a request of the first communication device. For example, as shown in step 2a to step 5b in FIG. 4, the first information is the first request message from another communication device. The AI service management function may request, according to the first request message, the corresponding modification of at least one of the data plane management function, the AI resource node, the AI model management function, and the AI resource management function. At least one of the data plane management function, the AI resource node, the AI model management function, and the AI resource management function responds to a modification request of the AI service management function. Optionally, at least one of the data plane management function, the AI resource node, the AI model management function, and the AI resource management function sends the modified content to the AI service management function.

It should be noted that considering that the AI session has a communication requirement (for example, QoS) and whether to modify an AI bearer and/or a communication bearer is not limited in an AI session modification process, in an AI session modification process, only an AI resource, only a communication resource, or both the AI resource and the communication resource may be modified.

Optionally, the step that the first network side device modifies the first session according to the first information includes the following step:
the first network side device modifies, according to the first information, at least one of the following of the first session:
a transmission mode of data of the first service;
a service resource of the first service;
a data source of the first service;
a model of the first service; and
a bearer of the first session.

In some implementations, the AI resource node may require the terminal to send data to assist a requirement at a network side, and for example, perform AI training. The requirement may be locally determined by the AI resource node. In some other implementations, the AI resource node may require the terminal to send AI service data in a particular mode due to a service requirement. In this case, the AI resource node may modify, according to the first information, a transmission mode in which the terminal sends the AI service data, such as a frequency and a period of transmission of the AI service data.

In some implementations, the AI resource management function may adjust the AI resource information of the terminal according to the first information. For example, because of the insufficient AI resource in the network or change of subscription information of the terminal, the AI resource information of the terminal is adjusted.

In some implementations, the data plane management function may modify the data source of the terminal in the AI service according to the first information.

In some implementations, the AI model management function may modify the model used by the terminal in the AI service according to the first information.

In some implementations, a communication management function may alternatively modify a communication bearer related to the first session according to the first information or session information related to the modified first session.

In some implementations, which one or more pieces of session information of the first session are modified may be determined through condition determination.

### Mode One: Determination of Whether to Modify Model Information of a First Service

In one optional implementation, the step that the first network function modifies the first session according to the first information includes the following step:
the first network function modifies a model used by the terminal in the first session in a case that it is determined that the first information satisfies a first condition.

The first condition includes at least one of the following:
requirement description information of the first service includes the model information;
the requirement description information of the first service includes QoS information of the first service, and the QoS information of the first service does not match the model information used by the terminal in the first session;
the second information includes QoS information related to the first session, and the QoS information related to the first session does not match the model information used by the terminal in the first session; and
the first indication information indicates that interaction with the second network function is needed.

In one implementation, in a case that the first information includes the requirement description information of the first service and the requirement description information of the first service includes the model information, the first request message may request modification of the model information of the first service, such as a model identity, model precision, and a model downloading address, or a network side may modify the model information of the first service based on its own requirement.

In one implementation, in a case that the requirement description information of the first service includes the QoS information of the first service and the QoS information of the first service does not match the model information used by the terminal, the first information may reflect that the QoS information of the first service needs to be modified, and the modified QoS information does not match the model information currently used by the terminal. Thus, the model information used by the terminal needs to be modified into the model information matching the modified QoS information of the first service.

In one implementation, in a case that the first request message includes the second information, the second information includes the QoS information related to the first session, and the QoS information related to the first session does not match the model information used by the terminal, the first request message may request modification of the QoS information of the first session, and the modified QoS information does not match the model information currently used by the terminal. Thus, the model information used by the terminal needs to be modified into model information matching the modified QoS information of the first session.

In one implementation, in a case that the first request message includes the first indication information, the first indication information indicates that interaction with the second network function is needed, and the second network function is used for managing a model, the first request message may request interaction with the second network function, and the model information of the first service may be modified according to an interaction result.

In the implementation, the first network function may trigger modification of the model information used by the terminal in a case that the first information satisfies the first condition.

### Mode Two: Determination of Whether to Modify Data Source Information of a First Service

In one optional implementation, the step that the first network function modifies the first session according to the first information includes the following step:
the first network function modifies a data source of the terminal in the first session in a case that it is determined that the first information satisfies a second condition.

The second condition includes at least one of the following:
the first request message carries data source information;
requirement description information of the first service includes model information, and the model information does not match the data source information used by the terminal in the first session;
the requirement description information of the first service includes QoS information of the first service, and the QoS information of the first service does not match the data source information used by the terminal in the first session;
the third information includes QoS information related to the first session, and the QoS information related to the first session does not match the data source information used by the terminal in the first session; and
the first indication information indicates that interaction with the fourth network function is needed.

In one implementation, in a case that the first request message carries the data source information, the first request message may request modification of the data source information of the first service into the carried data source information.

In one implementation, in a case that the first information includes the first indication information, the first indication information indicates that interaction with the fourth network function is needed, and the fourth network function is used for executing data management, the first information may indicate that interaction with the fourth network function is needed, and the data source information of the first service may be modified according to an interaction structure.

In one implementation, in a case that the requirement description information of the first service includes the model information and the model information does not match the data source information used by the terminal in the first session, the first information may indicate that the model information of the first service needs to be modified, and the modified model information does not match the data source information currently used by the terminal. Thus, the data source information of the first session used by the terminal needs to be modified into data source information matching the modified model information of the first service.

In one implementation, in a case that the requirement description information of the first service includes the QoS information of the first service and the QoS information of the first service does not match the data source information used by the terminal in the first session, the first information may indicate that the QoS information of the first service needs to be modified, and the modified QoS information of the first service does not match the data source information currently used by the terminal. Thus, the data source information of the first session used by the terminal needs to be modified into the data source information matching the modified QoS information of the first service.

In one implementation, in a case that the second information in the first request message includes the QoS information related to the first session, and the QoS information related to the first session does not match the data source information used by the terminal in the first session, the first request message may request modification of the QoS information related to the first session, and the QoS information of the modified first session does not match the data source information currently used by the terminal. Thus, the data source information used by the terminal needs to be modified into data source information matching the modified QoS information of the first session.

In the implementation, the first network function may trigger modification of the data source information used by the terminal in a case that the first information satisfies the second condition.

### Mode Three: Determination of Whether to Modify Service Resource Information of a First Service

In one optional implementation, the step that the first network function modifies the first session according to the first information includes the following step:
the first network side device modifies a service resource used by the terminal in the first session in a case that it is determined that the first information satisfies a third condition.

The third condition includes at least one of the following:
requirement description information of the first service includes model information, and the model information does not match service resource information used by the terminal in the first session;
the requirement description information of the first service includes QoS information of the first service, and the QoS information of the first service does not match the service resource information used by the terminal in the first session;
the third information includes QoS information related to the first session, and the QoS information related to the first session does not match the service resource information used by the terminal in the first session; and
the first indication information indicates that interaction with the third network function is needed.

In one implementation, in a case that the requirement description information of the first service includes the model information and the model information does not match the service resource information used by the terminal in the first session, the first information may indicate that the model information of the first service needs to be modified, and the modified model information does not match the service resource information currently used by the terminal. Thus, the service resource information of the first service used by the terminal needs to be modified into the service resource information matching the modified model information of the first service.

In one implementation, in a case that the requirement description information of the first service includes the QoS information of the first service and the QoS information of the first service does not match the service resource information used by the terminal in the first session, the first information may indicate that the QoS information of the first service needs to be modified, and the QoS information of the modified first service does not match the service resource information of the first service currently used by the terminal. Thus, the service resource information of the first service used by the terminal needs to be modified into the service resource information matching the modified QoS information of the first service.

In one implementation, in a case that the second information in the first request message includes the QoS information related to the first session, and the QoS information related to the first session does not match the service resource information used by the terminal in the first session, the first request message may request modification of the QoS information related to the first session, and the QoS information of the modified first session does not match the service resource information of the first service currently used by the terminal. Thus, the service resource information of the first service used by the terminal needs to be modified into service resource information matching the modified QoS information of the first session.

In one implementation, in a case that the first indication information indicates that interaction with the third network function is needed and the third network function is used for managing a service resource, the first information may indicate that interaction with the third network function is needed, and the service resource information of the first service may be modified according to an interaction result.

In the implementation, the first network function may trigger modification of a service resource used by the terminal in a case that the first information satisfies the third condition.

It is worth pointing out that in addition to the mode one to the mode three, the first network function may further trigger modification of the AI bearer, the communication bearer, or the transmission mode of data of the first service of the first session. This is not specifically limited herein.

It should be noted that at least two of the first network function, the second network function, the third network function, the fourth network function, and the first resource node may be combined in the same network side device, or the first network function, the second network function, the third network function, the fourth network function, and the first resource node may be separately arranged in different network side devices.

In a case that the first network function, the second network function, the third network function, the fourth network function, and the first resource node may be separately arranged in different network side devices, the first network function needs to separately interact with the second network function, the third network function, the fourth network function, and the first resource node, to implement modification of the first session and feedback of a modification result. For example, as shown in step 2a to step 5b in FIG. 4, in a case that the first network side device receives the first request message from the first communication device, the first network function needs to interact with the second network function, to modify a model of the first service. Or, the first network function needs to interact with the third network function, to modify a resource of the first service. Or, the first network function needs to interact with the fourth network function, to modify a data source of the first service. Or, the first network function needs to interact with the first resource node, to modify a bearer of the first service.

In a case that at least two of the first network function, the second network function, the third network function, the fourth network function, and the first resource node may be combined in the same network side device, interaction between at least two combined logical functions may be omitted. For convenience of description, the embodiment of the present disclosure performs illustration with a case of separately arranging the first network function, the second network function, the third network function, the fourth network function, and the first resource node in different network side devices as an example, and an interaction process between the first network function, the second network function, the third network function, the fourth network function, and the first resource node is not limited herein.

Mode One: Interaction of a First Network Function with a Second Network Function to Modify Model Information of a First Service

In one optional implementation, in a case that the first network side device is the first network function, the method further includes the following steps:
the first network side device sends a fifth request message to the second network function according to the first request message, where the fifth request message is used for requesting modification of the model used by the terminal in the first session; and
the first network side device receives a fifth response message from the second network function, where the fifth response message indicates a modification result of the model used by the terminal in the first session.

The fifth request message may be referred to as a model modification request message, and is used for requesting modification of a model of the first service. In addition, the fifth response message may be a model modification response message.

Optionally, the fifth request message includes at least one of the following:
an identity of the terminal;
a data network name DNN to which the first session belongs;
single network slice selection assistance information S-NSSAI of the first session;
service zone information to which the first session belongs; and
requirement description information of the first service.

The second network function, for example, an AI model management function, may select updated model information according to the fifth request message.

Optionally, the fifth response message indicates a modification result of the model of the first service. Specifically, the model modification response message may include the updated model information, or the model modification response message may be a model modification request message ACK or a model modification request message negative acknowledgement (NACK).

For example, as shown in step 2a and step 2b in FIG. 4, an AI service management function sends the model modification request message to the AI model management function. The model modification request message may carry model information to be modified. Then, the AI model management function feeds back the model modification response message to the AI service management function. The model modification response message may carry the modified model information.

In one implementation, the updated model information may be model information requested by the terminal, and may be used after authorized by the AI model management function.

In another implementation, the updated model information may be model information selected by the AI model management function based on requirement description information of an AI service, the service zone information, and other information of the terminal.

Whether the updated model information is the same as model information determined during establishment of an AI session is not limited in the embodiment of the present disclosure.

Mode Two: Interaction of a First Network Function with a Fourth Network Function to Modify Data Source Information of a First Service

In one optional implementation, in a case that the first network side device is the first network function, the method further includes the following steps:
the first network side device sends a sixth request message to the fourth network function according to the first request message, where the sixth request message is used for requesting modification of the data source information of the terminal in the first session; and
the first network side device receives a sixth response message from the fourth network function, where the sixth response message indicates a modification result of the data source information of the terminal in the first session.

The sixth request message may be referred to as a data source modification request message, and is used for requesting modification of data source information of the first service. In addition, the sixth response message may be a data source modification response message.

The sixth response message indicates a modification result of a data source of the first service. Specifically, the data source modification response message may include the updated data source information, or the data source modification response message may be a data source modification request message ACK or a data source modification request message NACK.

For example, as shown in step 3a and step 3b in FIG. 4, an AI service management function sends the data source modification request message to a data plane management function. The data source modification request message may carry data source information to be modified. Then, the data plane management function feeds back the data source modification response message to the AI service management function. The data source modification response message may carry the modified data source information.

Optionally, the sixth request message includes at least one of the following:
an identity of the terminal;
a data network name DNN to which the first session belongs;
single network slice selection assistance information S-NSSAI of the first session;
service zone information to which the first session belongs; and
the requirement description information of the first service.
   Mode Three: Interaction of a First Network Function with a Third Network Function to Modify Resource Information of a First Service

In one optional implementation, in a case that the first network side device is the first network function, the method further includes the following steps:
the first network side device sends a seventh request message to the third network function according to the first request message, where the seventh request message is used for requesting modification of the service resource used by the terminal in the first session; and
the first network side device receives a seventh response message from the third network function, where the seventh response message indicates a modification result of the service resource used by the terminal in the first session.

The seventh request message may be referred to as an AI resource modification request message, and is used for requesting modification of AI resource information of the first service. In addition, the seventh response message may be an AI resource modification response message.

Optionally, the seventh response message indicates a modification result of the AI resource information of the first service. Specifically, the AI resource modification response message may include the updated AI resource information, or the AI resource modification response message may be an AI resource modification request message ACK or an AI resource modification request message NACK.

For example, as shown in step 4a and step 4b in FIG. 4, an AI service management function sends the AI resource modification request message to an AI resource management function. The AI resource modification request message may carry at least one of model information, a data source and other information. Then, the AI resource management function feeds back the AI resource modification response message to the AI service management function. The AI resource modification response message may carry the modified AI resource information, such as an AI resource address, a computing power type, and a computing power magnitude.

Optionally, the seventh request message includes at least one of the following:
an identity of the terminal;
a data network name DNN to which the first session belongs;
single network slice selection assistance information S-NSSAI of the first session;
service zone information to which the first session belongs;
requirement description information of the first service;
data source information of the first service, and for example, an data source identity, and data source address information;
a computational load of the first service, and for example, a computing power magnitude, and a computing power type; and
application server AS address information of the first service. The address information includes at least one of an IP address, a port number, an FQDN, a uniform resource locator (URL), and other address information.

Optionally, the AI resource modification response message includes AI resource node information. The AI resource node information includes at least one of the following: address information (where the address information includes an IP address, a port number, an FQDN, and a URL), and ID information.

Mode Four: Interaction of a First Network Function with a First Resource Node to Modify a Bearer of a First Session

In one optional implementation, in a case that the first network side device is the first network function, the method further includes the following steps:
the first network side device sends an eighth request message to the first resource node according to the first request message, where the eighth request message is used for requesting modification of the bearer of the first session, and the eighth request message includes the service resource configuration information; and
the first network side device receives an eighth response message from the first resource node, where the eighth response message indicates a modification result of the bearer of the first session.

The eighth request message may be referred to as an AI bearer modification request message, and is used for requesting modification of the bearer of the first session. In addition, the eighth response message may be an AI bearer modification response message.

Optionally, the eighth response message indicates a modification result of the bearer of the first session. Specifically, the AI bearer modification response message may include updated AI bearer information, or the AI bearer modification response message may be an AI bearer modification request message ACK or an AI bearer modification request message NACK.

The AI bearer modification request message may carry AI resource configuration information. The AI resource configuration information may include at least one of the following: data source information (a data source address or a data source identity), AI service detection information, AI service processing rule, and the AS address information.

For example, as shown in step 5a and step 5b in FIG. 4, an AI service management function sends the AI bearer modification request message to an AI resource node. The AI bearer modification request message may carry the AI resource configuration information. Then, the AI resource node feeds back the AI bearer modification response message to the AI service management function. The AI bearer modification response message may carry the modified AI bearer information.

In one optional implementation, the method further includes the following step:
the first network side device modifies a service policy of the first service according to the modified first session.

In some implementations, the service policy includes at least one of the following:
data transmission resource information related to the data of the first service, a data forwarding rule related to the data of the first service, a data caching rule related to the data of the first service, and network context information related to the data of the first service; and a data matching policy of a terminal side for the first session, and a data sending policy of the terminal side for the first session.

The data forwarding rule related to the data of the first service and the data caching rule related to the data of the first service are a data forwarding rule and a data caching rule of the data of the first service applied to a network side. The data matching policy of the terminal side for the first session and the data sending policy of the terminal side for the first session are a data matching policy used for matching service data of the first session and the data sending policy used for sending the service data of the first session applied to the terminal side.

In the implementation, the AI service management function may modify, based on the first request message, at least one of the following of an AI session: a transmission mode of the data of the first service, a service resource of the first service, a data source of the first service, a model of the first service, and a bearer of the first session. Then, modification of an AI policy may be triggered based on at least one of the above modified information. For example, as shown in FIG. 3, the AI service management function may trigger an AI policy modification process according to the information obtained in step 1a to step 1d.

In some implementations, the first network side device may further send a notification message to at least one of the terminal and the AI resource node. As shown in step 2a in FIG. 3, the AI service management function sends an information update notification message to the AI resource node based on the information obtained in step 1a to step 1d, to notify the AI resource node of at least one of session information of the modified first session and the modified AI policy.

Then, the AI resource node may provide an AI service for the terminal through the AI session based on the session information of the modified first session or modified AI policy information.

In one optional implementation, in a case that the first information includes the first request message, the step that the first network side device obtains the first information includes the following step:
the first network side device receives the first request message from a first communication device.

The first communication device may be at least one of an application function (AF), an over the top (OTT, that is, an Internet company over an operator) server, and the terminal.

For example, as shown in any one of the embodiments in FIG. 4 to FIG. 7, the OTT server sends an AI session modification request message. The AI session modification request message is transmitted to the AI service management function through at least one of an NEF, a UDR, a policy charging function, and a communication management function, such that the AI service management function modifies the AI session according to an AI session request message.

In some implementations, as shown in FIG. 4, after receiving the first request message and modifying the first session, the first network side device may send a first response message to the first communication device. The first response message indicates a modification result of the first session. For example, the AI service management function notifies the first communication device of at least one of information such as a session ID, QoS information, AI policy information, AI resource configuration information, data source information, and model information of the modified first session through the first response message.

Or, the first response message may not include the session information of the modified first session. For example, the AI service management function feeds back a first request message ACK or a first request message NACK to the first communication device.

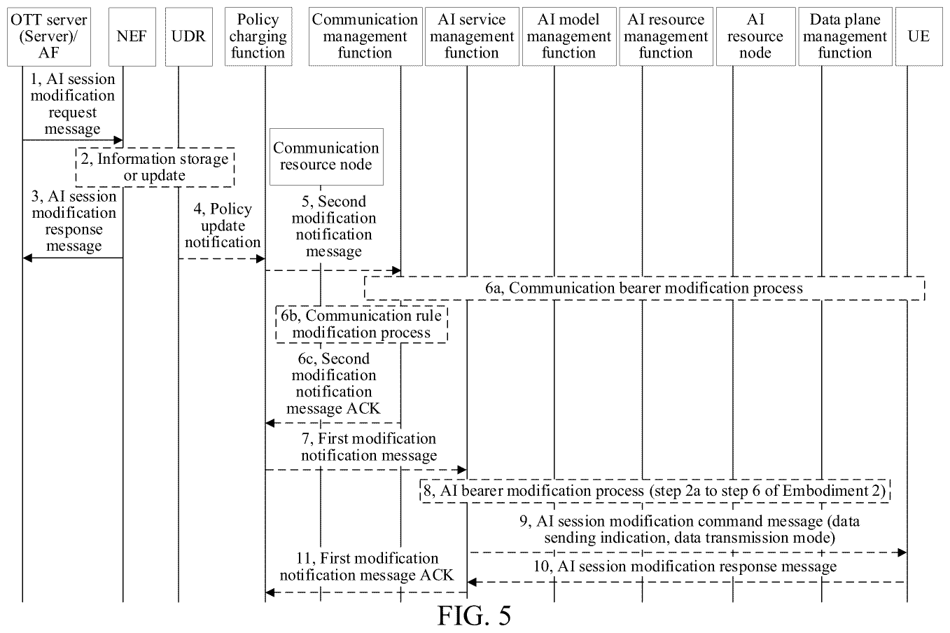

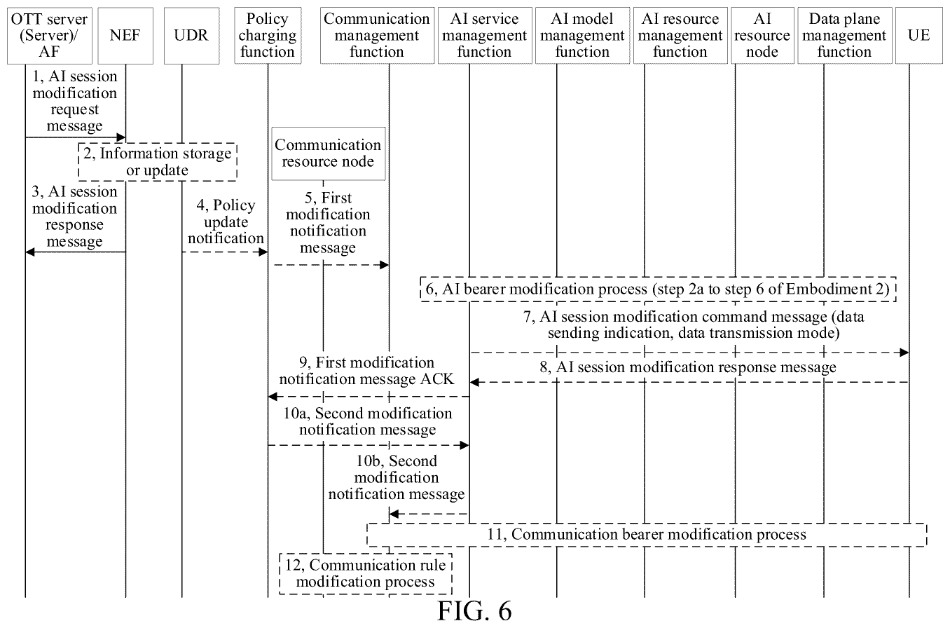

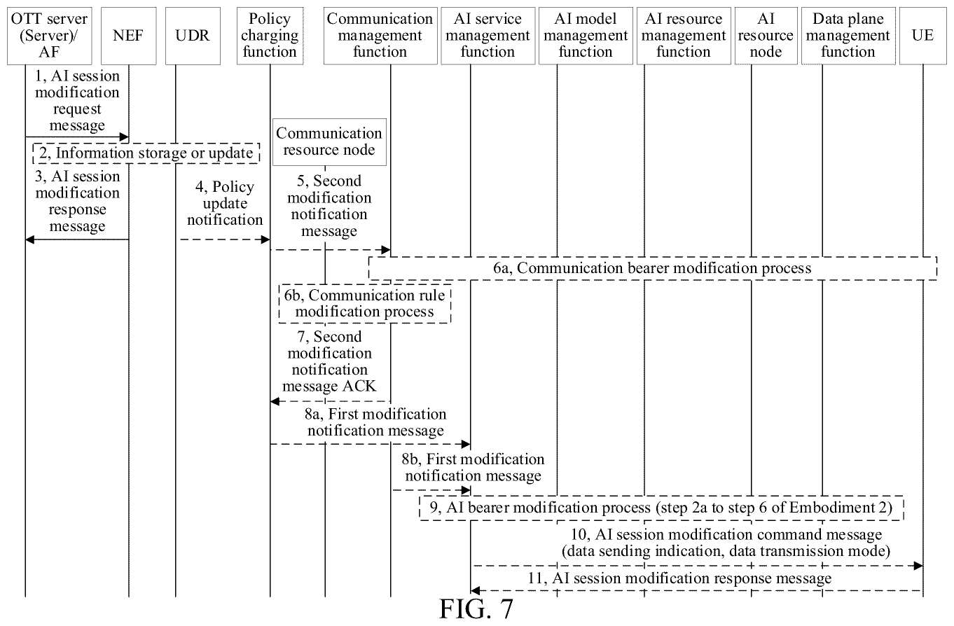

In some other implementations, as shown in FIG. 5, FIG. 6, or FIG. 7, after receiving the first request message sent by the first communication device, the NEF may authenticate the first request message, and store a parameter requested in the first request message in the UDR. In addition, the NEF feeds back the first response message to the first communication device according to an authentication result of the first request message. The first response message may be used for indicating a request result of the first request message. Then, the UDR may notify the policy charging function of updating of policy information according to the stored information. The policy information includes an AI-related policy (i.e. an AI policy) and a communication-related policy (i.e. a communication policy).

In one implementation, after the policy charging function updates the AI policy information, the AI service management function may be notified of corresponding modification of the AI session.

For example, the step that the first network side device obtains the first information includes the following step:
the first network side device receives a first notification message from a third network side device. The first notification message is used for notifying the first network side device of modification of the first session.

The third network side device may be a network element of the policy charging function.

Optionally, the method further includes the following step:
the first network side device sends a first response message to the third network side device. The first response message indicates a modification result of the first session.

In another implementation, after the policy charging function updates communication policy information, the communication management function may be notified of corresponding modification of a communication bearer related to the AI session.

It should be noted that, modification of the AI session and modification of the communication bearer related to the AI session may be two processes independent of each other. For example, as shown in FIG. 5, in a case that the policy charging function updates the AI policy information and the communication policy information, the policy charging function sends the first notification message and a second notification message to the AI service management function and the communication management function, respectively. The first notification message may notify the AI service management function of modification of the AI session, and for example, AI session modification, AI rule modification, or UE policy modification. The second notification message may notify the communication management function of modification of the communication bearer related to the AI session.

Clearly, modification of the AI session and modification of the communication bearer related to the AI session may be two related processes.

In some implementations, the policy charging function determines QoS information of the AI session based on QoS information between a communication resource node and the AI resource node. In some implementations, the policy charging function determines QoS information of an AI communication bearer based on the AI session information.

Optionally, the first notification message includes at least one of the following:
second information, and for example, PDU session information, where the second information is used for indicating allocation of a communication resource corresponding to the AI session by a network; and the second information includes a PDU session ID, a PDU session type, QoS information (such as a QoS flow identity, a QoS rule, and QoS flow description information), a DNN, and S-NSSAI; and
third information, and for example, AI session information, where the third information is used for describing one AI session, and includes an AI session ID, an AI session type, a DNN related to the AI session, a slice related to the AI session, and QoS information (such as a QoS flow identity, a QoS rule, and QoS flow description information) related to the AI session.

In some implementations, the method further includes the following step:
the first network side device sends fifth information to a second network side device. The fifth information includes at least one of the following:
session information of the modified first session; and
a second notification message. The second notification message is used for indicating modification of a communication bearer or a communication policy related to the first session.

The second network side device may be a network element of the communication management function.

Optionally, the second notification message includes at least one of the following:
second information, and for example, PDU session information, where the second information is used for indicating allocation of a communication resource corresponding to the AI session by a network; and the second information includes a PDU session ID, a PDU session type, QoS information (such as a QoS flow identity, a QoS rule, and QoS flow description information), a DNN, and S-NSSAI; and
third information, and for example, AI session information, where the third information is used for describing one AI session, and includes an AI session ID, an AI session type, a DNN related to the AI session, a slice related to the AI session, and QoS information (such as a QoS flow identity, a QoS rule, and QoS flow description information) related to the AI session.

In one implementation, after the AI service management function completes modification of the AI session, the AI service management function may determine how to modify the communication bearer or the communication policy related to the first session according to the modified first session. In this way, the second notification message notifies the communication management function of modification of the communication bearer or the communication policy related to the first session according to the second notification message.

For example, as shown in FIG. 6, after updating the AI policy information, the policy charging function sends the first notification message to the AI service management function through step 5, to notify the AI service management function of modification of the AI session. After completing modification of the AI session through step 6 to step 8, the AI service management function may directly send the second notification message to the communication management function through step 10b, to notify the communication management function of modification of the communication bearer related to the AI session.

Further, for example, as shown in FIG. 3, after the AI service management function modifies the AI session or modifies the AI policy, session information of the modified AI session is sent to the communication management function through step 3. In this way, the communication management function modifies the communication bearer or the communication policy related to the AI session according to the session information of the modified AI session. Or, as shown in step 4 in FIG. 3, after the AI service management function modifies the AI session or modifies the AI policy, the communication management function sends the second notification message (for example, a communication bearer modification notification), to notify the communication management function of modification of the communication bearer or the communication policy related to the AI session according to the second notification message.

Optionally, the second notification message includes second indication information. The second indication information indicates modification of QoS information of the communication bearer related to the first session by the second network side device.

For example, according to an end-to-end QoS requirement between the terminal and the first resource node and a QoS requirement from the communication resource node (for example, a UPF) to the first resource node, the communication bearer is updated.

Optionally, the method further includes the following step:
the first network side device receives a second response message from the second network side device. The second response message is a response message to the second notification message.

In another implementation, after completing modification of the AI session, the AI service management function may send the session information, for example, at least one of service policy information, the service resource configuration information, the data source information, and the model information, of the modified first session to the communication management function. In this way, the communication management function may trigger modification of at least one of the communication bearer or the communication policy related to the first session according to the session information of the modified first session. For example, the communication management function initiates a PDU session modification process according to the session information of the modified first session.

It is worth pointing out that the two implementations may be combined. For example, the first network side device sends the session information of the modified first session and the second notification message to the communication management function. In this way, the communication management function determines whether to modify, according to the session information of the modified first session, the communication bearer related to the first session according to a notification of the second notification message.

Optionally, the communication policy includes a related policy used for communication or routing at the network side or the terminal side.

In some implementations, a communication policy modification process is an SM policy association modification process.

In some implementations, the communication policy modification process is a UE policy modification process.

In some implementations, the communication policy modification process is used for modifying route information in the network, such as a forwarding action rule (FAR) and a packet detection rule (PDR).

In the implementation, after the first session is modified, the fifth information may be sent to the communication management function. In this way, the communication management function triggers modification of the communication bearer or the communication policy related to the first session.

In another implementation, after completing modification of the AI session, the AI service management function may feed back a modification result of the AI session to the policy charging function. In this way, the policy charging function sends a fourth notification message to the communication management function according to the modification result of the AI session, such that the communication management function modifies the communication-related policy according to the fourth notification message.

For example, as shown in FIG. 6, after completing modification of the AI session through step 6 to step 8, the AI service management function may feed back the modification result of the AI session to the policy charging function through step 9. In step 10a, the policy charging function sends the fourth notification message to the communication management function according to the modified AI session, to notify the communication management function of modification of the communication bearer related to the AI session.

Clearly, in addition to modification of the communication policy based on a modification result of the AI policy, the communication policy may be modified first, and the AI policy may be modified according to a modification result of the communication policy.

For example, as shown in FIG. 7, after updating the communication policy information, the policy charging function sends the second notification message to the communication management function through step 5, to notify the communication management function of modification of the communication bearer related to the AI session. After completing modification of the communication bearer through at least one of step 6a and step 6b, the communication management function may directly send the first notification message to the AI service management function through step 8b, to notify the AI service management function of modification of the AI session. Or, after completing modification of a communication session through at least one of step 6a and step 6b, the communication management function may feed back a modification result of the communication bearer to the policy charging function through step 7. In step 8a, the policy charging function sends the first notification message to the AI service management function according to the modified communication bearer, to notify the AI service management function of modification of the AI session.

As one optional implementation, the step that the first network side device obtains the first information includes the following step:
the first network side device receives a third notification message from the second network side device. The third notification message is used for notifying the first network side device of modification of the service policy related to the first session.

The step that the first network side device modifies the first session according to the first information includes the following steps:
the first network side device modifies the service policy related to the first session according to the third notification message, and modifies the first session according to the modified service policy.

The third notification message is similar to the first notification message. Their differences are as follows: The first notification message is a notification message sent by the third network side device, and for example, a notification message, used for notifying the AI service management function of modification of the AI policy, sent by the policy charging function. The third notification message is sent by the second network side device. For example, the third notification message is a notification message, used for notifying the AI service management function of modification of the AI policy related to the communication policy, sent to the AI service management function after the communication management function modifies the communication policy. A content of the third notification message will not be repeated herein.

In the implementation, the second network side device may modify the communication policy, and then the second network side device may notify the first network side device of modification of the AI session related to the communication policy.

It should be noted that, after modifying the communication policy, the second network side device may feed back the modification result of the communication policy to the policy charging function. Then, the policy charging function notifies the first network side device of modification of the first session according to the modification result of the communication policy.

In addition, a first session modification process and a modification process of the communication bearer related to the first session may be two independent processes that are executed in parallel. Or, the first session may be modified, and then the modification process of the communication bearer related to the first session may be triggered according to the modification result of the first session. Or, the communication bearer may be modified, and then the modification process of the first session related to the communication bearer may be triggered according to the modification result of the communication bearer.

### Mode One: Independent Modification of an AI Bearer and a Communication Bearer

In the implementation, the third network side device sends a first notification message to a first network side device and a fourth notification message to a second network side device according to the fifth notification message.

For example, as shown in FIG. 5, an interaction process of a policy charging function, a communication management function, and an AI service management function includes the following steps:
Step 5, the policy charging function sends the fourth notification message to the communication management function, to modify a communication-related policy, and for example, modify a communication bearer, modify a communication rule, or modify a UE policy.
Step 6a, the communication management function modifies the communication bearer based on step 5.
Step 6b, the communication management function modifies the communication rule based on step 5.
Step 7, the policy charging function sends the first notification message to the AI service management function, to modify an AI-related policy, and for example, modify an AI session, modify an AI rule, or modify a UE policy.

It is worth pointing out that step 5 and step 7 may be independently triggered and executed in parallel.

Mode Two: Modification of an AI Bearer and then Modification of a Communication Bearer

In some implementations, the step that the first network side device obtains the first information includes the following step:
the first network side device receives a first notification message from a third network side device. The first notification message is used for notifying the first network side device of modification of the first session.

The method further includes the following step:
the first network side device sends a first response message to the third network side device. The first response message indicates a modification result of the first session.

The first response message is a response message to the first notification message. For example, the first notification message is a first modification notification message, and the first response message is a first modification notification message ACK. The first response message may indicate the modification result of the first session, such as an AI session ID or an AI policy after modification.

In one implementation, the step that the third network side device sends the fourth notification message to the second network side device according to the fifth notification message includes the following step:
the third network side device sends the fourth notification message to the second network side device according to the modification result of the first session.

For example, as shown in step 4 to step 10a in FIG. 6, in a case that a policy charging function receives a policy update notification (i.e. the fifth notification message), the policy charging function first sends the first notification message to an AI service management function, to notify the AI service management function of modification of an AI session. After completing modification of the AI session, the AI service management function feeds back the first response message to the policy charging function. The first response message indicates the modification result of the first session. Then, the policy charging function may send the fourth notification message to a communication management function based on session information of the modified AI session, to trigger modification of the communication bearer by the communication management function.

In another implementation, after completing modification of the first session, the first network side device directly sends fifth information to the second network side device, to trigger modification of the communication bearer by the second network side device.

For example, as shown in step 4 to step 6 and step 10b in FIG. 6, in a case that the policy charging function receives the policy update notification (i.e. the fifth notification message), the policy charging function sends the first notification message to the AI service management function, to notify the AI service management function of modification of the AI session. After completing modification of the AI session, the AI service management function sends a second notification message to the communication management function, to trigger modification of the communication bearer by the communication management function. The second notification message is used for indicating modification of the communication bearer or a communication policy related to the first session.

In the implementation, the first network side device may send, in the modified AI session, the fifth information to the second network side device, to trigger modification of the communication bearer by the second network side device.

Mode Three: Modification of a Communication Bearer and then Modification of an AI Bearer

In some implementations, the step that the first network side device obtains the first information includes the following step:
the first network side device receives a first notification message from a third network side device. The first notification message is used for notifying the first network side device of modification of the first session.

Prior to this, the third network side device first sends a fourth notification message to a second network side device, and obtains a fourth response message fed back by the second network side device. The first notification message is determined based on the modification result, indicated by the fourth response message, of the communication bearer related to the first session.

For example, as shown in step 4 to step 8a in FIG. 7, in a case that a policy charging function receives a policy update notification (i.e. the fifth notification message), the policy charging function first sends the fourth notification message to a communication management function, to notify the communication management function of modification of the communication bearer related to an AI session. After completing modification of the communication bearer, the communication management function feeds back the fourth response message to the policy charging function. The fourth response message indicates a modification result of the communication bearer related to the AI session. Then, the policy charging function may send the first notification message to an AI service management function based on the communication bearer related to the modified AI session, to trigger modification of the AI session by the AI service management function.

In another implementation, the step that the first network side device obtains the first information includes the following step:
the first network side device receives a third notification message from the second network side device. The third notification message is used for notifying the first network side device of modification of the service policy related to the first session.

After completing modification of the communication bearer related to the first session, the second network side device directly sends the third notification message to the first network side device, to trigger modification of the service policy related to the first session by the first network side device.

For example, as shown in step 4 to step 6b and step 8b in FIG. 7, in a case that the policy charging function receives the policy update notification (i.e. the fifth notification message), the policy charging function sends the fourth notification message to the communication management function, to notify the communication management function of modification of the communication bearer related to the AI session. After completing modification of the communication bearer related to the AI session, the communication management function sends a third notification message to the AI service management function, to trigger modification of the AI session by the AI service management function.

As one optional implementation, the method further includes the following step:
the first network side device sends a first command message to the terminal. The first command message is used for indicating modification of the first session by the terminal.

Optionally, the first command message includes at least one of the following:
the requirement description information of the first service;
a session type indication, where the session type indication indicates a type of a modified session;
the third information, where the third information is used for indicating information related to the first session;
a data transmission indication, where the data transmission indication indicates sending, by the terminal, service data associated with the requirement description information of the first service; and
a data transmission mode, where the data transmission mode indicates a transmission mode in which the terminal sends the service data associated with the requirement description information of the first service.

Optionally, the third information includes at least one of the following:
a session ID of the first session, a session type of the first session, a DNN related to the first session, a slice related to the first session, and QoS information related to the first session.

In the implementation, the terminal may be instructed to transmit AI service data according to the modified AI session through the first command message.

In the embodiments of the present disclosure, the first network side device obtains the first information. The first information includes at least one of the following: the requirement description information of the first service; the service resource configuration information; and the first request message. The first request message is used for requesting modification of the first session. The first network side device modifies the first session according to the first information. The first session is used for carrying the service data of the first service of the terminal. The first service includes at least one of the artificial intelligence AI service and the computing service. In this way, the first network side device can modify at least one of the AI service and the computing service in the first session according to its own requirements or requests of other devices.

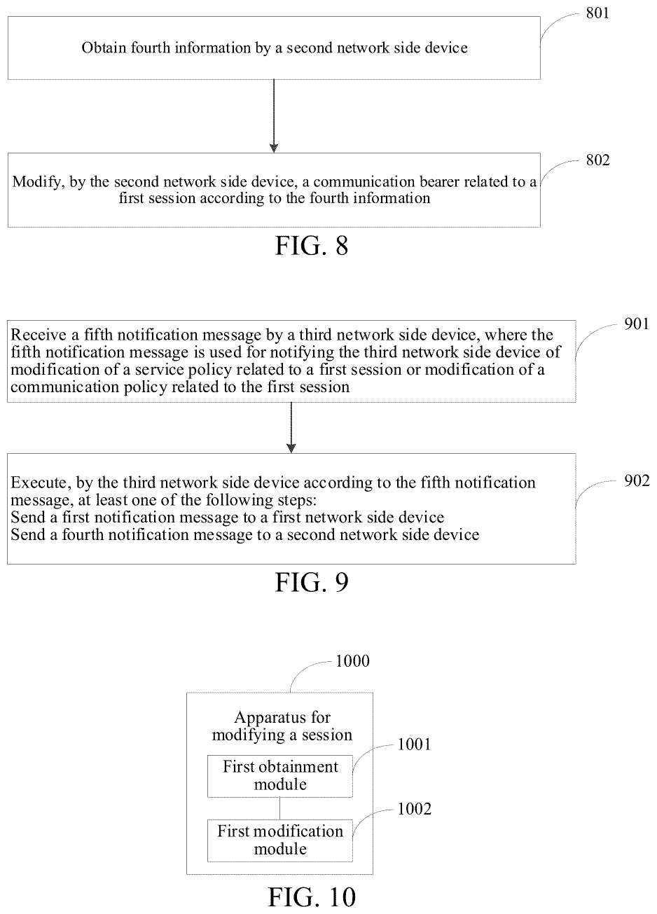

With reference to FIG. 8, an execution body of another method for modifying a session according to the embodiment of the present disclosure is a second network side device. As shown in FIG. 8, the method for modifying a session, executed by the second network side device, includes the following steps:

Step 801, the second network side device obtains fourth information.

The fourth information includes at least one of the following:
fifth information, where the fifth information includes session information of the modified first session or a second notification message from a first network side device, and the second notification message is used for indicating modification of the communication bearer or a communication policy related to the first session; and
a fourth notification message from a third network side device, where the fourth notification message is used for notifying the second network side device of modification of the communication policy related to the first session.

Step 802, the second network side device modifies the communication bearer related to the first session according to the fourth information. The first session is used for carrying service data of a first service. The first service includes at least one of an artificial intelligence AI service and a computing service.

It should be noted that, in the embodiment of the present disclosure, meanings of the fifth information, the first session, the first service, the second notification message, the communication bearer, the communication policy, the first network side device, the second network side device, and the third network side device are the same as meanings of the fifth information, the first session, the first service, the second notification message, the communication bearer, the communication policy, the first network side device, the second network side device, and the third network side device in the method embodiment shown in FIG. 2. Reference may be made to explanations and descriptions in the method embodiment shown in FIG. 2 for specific meanings. Details will not be described herein.

In addition, the fourth notification message may be similar to the second notification message. Their differences are as follows: The second notification message is sent by the first network side device. For example, the second notification message is a notification message, used for notifying the communication management function of modification of the communication bearer related to the AI session or modification of the communication policy related to an AI policy, sent to the communication management function after the AI service management function modifies the AI session or the AI policy. The fourth notification message is a notification message sent by the third network side device, and for example, a notification message, used for notifying the communication management function of modification of the communication policy, sent by the policy charging function. A content of the fourth notification message will not be repeated herein.

Optionally, the first session satisfies at least one of the following:
the first session is a bearer between a terminal and a first resource node;
the first session has a first identity used for uniquely identifying the first session;
the first session has at least one of a dedicated data network name DNN and single network slice selection assistance information S-NSSAI; and
the first session has a quality of service QoS assurance between the terminal and the first resource node.

The first resource node includes a network function for processing the first service.

In some implementations, a modification process of the communication bearer or the communication policy may be triggered based on modification of the first session or a modification result of a policy related to the first service by the first network side device.

For example, as shown in FIG. 3 or FIG. 4, after modifying the AI session or the AI policy, the AI service management function sends the fifth information to the communication management function. For example, the fifth information is the session information of the modified first session and/or the second notification message. The second notification message is used for indicating modification of the communication bearer or the communication policy related to the first session.

Further, for example, as shown in FIG. 6, after modifying the AI session or the AI policy, the AI service management function sends the second notification message to the communication management function through step 10b, or feeds back a modification result of the AI session to the policy charging function through step 9. Then, the policy charging function may send the fourth notification message to the communication management function through step 10a based on the modification result of the AI session.

Optionally, the service policy includes at least one of the following:
data transmission resource information related to the data of the first service, a data forwarding rule related to the data of the first service, a data caching rule related to the data of the first service, and network context information related to the data of the first service; and a data matching policy of a terminal side for the first session, and a data sending policy of the terminal side for the first session.

Optionally, the communication policy includes at least one of the following:
data transmission resource information related to communication of the first session, a data caching rule related to the communication of the first session, a data forwarding rule related to the communication of the first session, network context information related to the communication of the first session, a data matching policy of a terminal side for the communication bearer related to the first session, and a data sending policy of the terminal side for the communication bearer related to the first session.

In some implementations, modification of the communication bearer is a process of modifying a PDU session.

In some implementations, modification of the communication bearer is modification of information related to communication QoS.

In some implementations, modification of the communication policy is used for modifying a related policy used for communication or routing at a network or terminal side.

For example, a communication policy modification process is an SM policy association modification process, a terminal policy modification process, or used for modifying route information in the network, such as a forwarding action rule (FAR) and a packet detection rule (PDR).

Optionally, the session information includes at least one of the following:
service policy information, the service resource configuration information, the data source information, and the model information.

Optionally, in a case that the fourth information includes the second notification message from the first network side device, the method further includes the following step:
the second network side device sends a second response message to the first network side device. The second response message is a response message to the second notification message.

For example, as shown in FIG. 3 or FIG. 4, after the communication management function modifies the communication bearer or the communication policy related to the AI session according to the second notification message sent by the AI service management function, the communication management function feeds back a communication bearer modification positive acknowledgement (ACK) to the AI service management function.

As one optional implementation, in a case that the fourth information includes the fourth notification message, the step that the second network side device modifies the communication bearer related to the first session according to the fourth information includes the following steps:
the second network side device modifies the communication policy related to the first session according to the fourth notification message; and
the second network side device modifies the communication bearer or a communication rule related to the first session according to the modified communication policy.

For example, as shown in FIG. 5, in step 5, the policy charging function sends the fourth notification message to the communication management function, to modify a communication-related policy, and for example, modify the communication bearer, modify the communication rule, or modify a UE policy. Then, the communication management function modifies the communication bearer or the communication rule based on step 5.

In some implementations, modification of the communication bearer or the communication policy may trigger modification of the first session or modification of a policy related to the first service by the first network side device.

As one optional implementation, in a case that the fourth information includes the fourth notification message, the method further includes the following step:
the second network side device sends a fourth response message to the third network side device, where the fourth response message indicates a modification result of the communication bearer related to the first session;
or,
the second network side device sends a third notification message to the first network side device, where the third notification message is used for notifying the first network side device of modification of a service policy related to the first session.

In one implementation, as shown in step 7 in FIG. 7, after modifying the communication bearer or the communication policy, the communication management function sends the fourth response message to the policy charging function, to indicate the modification result of the communication bearer related to the first session. Then, the policy charging function may send the first notification message to a network element of the AI service management function based on the modification result of the communication bearer, to notify the network element of the AI service management function of modification of an AI-related policy, and for example, modification of the AI session, modification of an AI rule, or modification of the UE policy.

In another implementation, as shown in step 8b in FIG. 7, after modifying the communication bearer or the communication policy, the communication management function sends the third notification message to the network element of the AI service management function, to notify the network element of the AI service management function of modification of the AI-related policy, and for example, modification of the AI session, modification of the AI rule, or modification of the UE policy.

The embodiment of the present disclosure can be combined with the method embodiment shown in FIG. 2. Thus, the second network side device may modify the communication bearer or the communication policy related to the AI session according to a modification result of the first session by the first network side device or a modification notification of the third network side device. Details will not be described herein.

FIG. 9 is a flowchart of another method for modifying a session according to an embodiment of the present disclosure. An execution body of the method for modifying a session is a third network side device. As shown in FIG. 9, the method for modifying a session includes the following steps:

Step 901, the third network side device receives a fifth notification message. The fifth notification message is used for notifying the third network side device of modification of a service policy related to a first session or modification of a communication policy related to the first session. The first session is used for carrying service data of a first service. The first service includes at least one of an artificial intelligence AI service and a computing service.

Step 902, the third network side device executes, according to the fifth notification message, at least one of the following steps:
a first notification message is sent to a first network side device, where the first notification message is used for notifying the first network side device of modification of the first session; and
a fourth notification message is sent to a second network side device, where the fourth notification message is used for notifying the second network side device of modification of the communication policy related to the first session.

Optionally, the first session satisfies at least one of the following:
the first session is a bearer between a terminal and a first resource node;
the first session has a first identity used for uniquely identifying the first session;
the first session has at least one of a dedicated data network name DNN and single network slice selection assistance information S-NSSAI; and
the first session has a quality of service QoS assurance between the terminal and the first resource node.

The first resource node includes a network function for processing the first service.

The third network side device may be a network element of a policy charging function. The fifth notification message may come from a UDR. For example, as shown in FIG. 5 to FIG. 7, a first communication device, such as an OTT server, an AF, or a terminal, sends an AI session modification request message to an NEF. The NEF authenticates the AI session modification request message, and feeds back a first response message to the first communication device according to an authentication result. The AI session modification response message may be used for indicating a request result of the AI session modification request message. In addition, the NEF stores a parameter requested in the AI session modification request message in the UDR. The UDR sends a policy update notification to the policy charging function according to the stored information, to notify the policy charging function of updating of policy information. The policy information includes an AI-related policy (i.e. an AI policy) and a communication-related policy (i.e. a communication policy). In this case, the fifth notification message is the policy update notification from the UDR.

Optionally, in a case that the third network side device sends the first notification message to the first network side device according to the fifth notification message, the method further includes the following step:
the third network side device receives a first response message from the first network side device. The first response message indicates a modification result of the first session.

For example, assuming that the first notification message is a first modification notification message, the first response message may be a first modification notification message ACK.

Optionally, in a case that the third network side device sends the fourth notification message to the second network side device according to the fifth notification message, the method further includes the following step:
the third network side device receives a fourth response message from the second network side device. The fourth response message indicates a modification result of a communication bearer related to the first session.

For example, assuming that the fourth notification message is a second modification notification message, the fourth response message may be a second modification notification message ACK.

In one implementation, the third network side device sends the first notification message to the first network side device and the fourth notification message to the second network side device according to the fifth notification message. In this case, the first notification message is used for triggering modification of the first session by the first network side device, and the fourth notification message is used for triggering modification of the communication bearer by the second network side device.

In the implementation, a first session modification process and a communication bearer modification process are two independent processes that are executed in parallel.

In another implementation, the first session may be modified, and then modification of the communication bearer may be triggered according to the modification result of the first session.

Optionally, the step that the third network side device sends the fourth notification message to the second network side device according to the fifth notification message includes the following step:
the third network side device sends the fourth notification message to the second network side device according to the modification result of the first session.

The modification result of the first session may be obtained based on the first response message received by the third network side device.

For example, as shown in step 4 to step 10a in FIG. 6, in a case that a policy charging function receives a policy update notification (i.e. the fifth notification message), the policy charging function first sends the first notification message to an AI service management function, to notify the AI service management function of modification of an AI session. After completing modification of the AI session, the AI service management function feeds back the first response message to the policy charging function. The first response message indicates the modification result of the AI session. Then, the policy charging function may send the fourth notification message to a communication management function based on session information of the modified AI session, to trigger modification of the communication bearer by the communication management function.

In another implementation, after completing modification of the first session, the first network side device directly sends fifth information to the second network side device, to trigger modification of the communication bearer by the second network side device.

For example, as shown in step 4 to step 6 and step 10b in FIG. 6, in a case that the policy charging function receives the policy update notification (i.e. the fifth notification message), the policy charging function sends the first notification message to the AI service management function, to notify the AI service management function of modification of the AI session. After completing modification of the AI session, the AI service management function sends a second notification message to the communication management function, to trigger modification of the communication bearer by the communication management function. The second notification message is used for indicating modification of the communication bearer or a communication policy related to the first session.

In yet another implementation, the communication bearer may be modified, and then modification of the first session may be triggered according to the modification result of the communication bearer.

Optionally, the step that the third network side device sends the first notification message to the first network side device according to the fifth notification message includes the following step:
the third network side device sends the first notification message to the first network side device according to the modification result of the communication bearer related to the first session.

The modification result of the communication bearer related to the first session may be obtained based on the fourth response message received by the third network side device.

For example, as shown in step 4 to step 8a in FIG. 7, in a case that a policy charging function receives a policy update notification (i.e. the fifth notification message), the policy charging function first sends the fourth notification message to a communication management function, to notify the communication management function of modification of the communication bearer related to an AI session. After completing modification of the communication bearer, the communication management function feeds back the fourth response message to the policy charging function. The fourth response message indicates a modification result of the communication bearer related to the AI session. Then, the policy charging function may send the first notification message to an AI service management function based on the communication bearer related to the modified AI session, to trigger modification of the AI session by the AI service management function.

In another implementation, after completing modification of the communication bearer related to the first session, the second network side device directly sends the third notification message to the first network side device, to trigger modification of the service policy related to the first session by the first network side device.

For example, as shown in step 4 to step 6b and step 8b in FIG. 7, in a case that the policy charging function receives the policy update notification (i.e. the fifth notification message), the policy charging function sends the fourth notification message to the communication management function, to notify the communication management function of modification of the communication bearer related to the AI session. After completing modification of the communication bearer related to the AI session, the communication management function sends a third notification message to the AI service management function, to trigger modification of the AI session by the AI service management function.

The embodiment of the present disclosure can be combined with the method embodiments shown in FIG. 2 and FIG. 8. Thus, the third network side device can control the first network side device to modify the first session, or control the second network side device to modify the communication bearer related to the first session. Details will not be described herein.

An execution body of the method for modifying a session according to the embodiment of the present disclosure may be an apparatus for modifying a session. In the embodiment of the present disclosure, the apparatus for modifying a session according to an embodiment of the present disclosure is illustrated with a case of using the apparatus for modifying a session to execute the method for modifying a session as an example.

With reference to FIG. 10, the apparatus 1000 for modifying a session according to the embodiment of the present disclosure may be a first network side device, and for example, an apparatus in a network element of an AI service management function. As shown in FIG. 10, the apparatus 1000 for modifying a session may include the following modules:
a first obtainment module 1001, configured to obtain first information; and
a first modification module 1002, configured to modify a first session according to the first information. The first session is used for carrying service data of a first service of a terminal. The first service includes at least one of an artificial intelligence AI service and a computing service.

The first information includes at least one of the following:
requirement description information of the first service;
service resource configuration information; and
a first request message. The first request message is used for requesting modification of the first session.

Optionally, the first session satisfies at least one of the following:
the first session is a bearer between a terminal and a first resource node;
the first session has a first identity used for uniquely identifying the first session;
the first session has at least one of a dedicated data network name DNN and single network slice selection assistance information S-NSSAI; and
the first session has a quality of service QoS assurance between the terminal and the first resource node.

The first resource node includes a network function for processing the first service.

Optionally, the first network side device includes at least one of the following:
a first network function, where the first network function is used for managing the first service;
a second network function, where the second network function is used for managing a model;
a third network function, where the third network function is used for managing a service resource;
the first resource node; and
a fourth network function, where the fourth network function is used for executing data management.

Optionally, the first modification module 1002 is specifically configured to modify, according to the first information, at least one of the following of the first session:
a transmission mode of data of the first service;
a service resource of the first service;
a data source of the first service;
a model of the first service; and
a bearer of the first session.

Optionally, in a case that the first information includes the first request message, the first obtainment module 1001 is specifically configured to:
receive the first request message from a first communication device.

Optionally, the first request message includes at least one of the following: the requirement description information of the first service;
second information, where the second information includes information of a communication resource related to the first session; and
third information, where the third information includes information of the first session.

Optionally, the requirement description information of the first service includes at least one of the following:
an identity of the first service;
a QoE requirement of the first service;
QoS information of the first service;
model information of the first service; and
first indication information, where the first indication information is used for indicating whether interaction with a target network function is needed.

Optionally, the first modification module 1002 is specifically configured to:
modify a model used by the terminal in the first session in a case that it is determined that the first information satisfies a first condition.

The first condition includes at least one of the following:
the requirement description information of the first service includes the model information;
the requirement description information of the first service includes the QoS information of the first service, and the QoS information of the first service does not match the model information used by the terminal in the first session;
the third information includes QoS information related to the first session, and the QoS information related to the first session does not match the model information used by the terminal in the first session; and
the first indication information indicates that interaction with the second network function is needed.

Optionally, the first modification module 1002 is specifically configured to:
trigger modification of a data source of the terminal in the first session in a case that it is determined that the first information satisfies a second condition.

The second condition includes at least one of the following:
the first request message carries data source information;
the requirement description information of the first service includes the model information, and the model information does not match the data source information used by the terminal in the first session;
the requirement description information of the first service includes the QoS information of the first service, and the QoS information of the first service does not match the data source information used by the terminal in the first session;
the third information includes QoS information related to the first session, and the QoS information related to the first session does not match the data source information used by the terminal in the first session; and
the first indication information indicates that interaction with the fourth network function is needed.

Optionally, the first modification module 1002 is specifically configured to:
modify a service resource used by the terminal in the first session in a case that it is determined that the first information satisfies a third condition.

The third condition includes at least one of the following:
the requirement description information of the first service includes the model information, and the model information does not match service resource information used by the terminal in the first session;
the requirement description information of the first service includes the QoS information of the first service, and the QoS information of the first service does not match the service resource information used by the terminal in the first session;
the third information includes QoS information related to the first session, and the QoS information related to the first session does not match the service resource information used by the terminal in the first session; and
the first indication information indicates that interaction with the third network function is needed.

Optionally, in a case that the first network side device is the first network function, the apparatus 1000 for modifying a session further includes:
a first sending module, configured to send a fifth request message to the second network function according to the first request message, where the fifth request message is used for requesting modification of the model used by the terminal in the first session; and
a second reception module, configured to receive a fifth response message from the second network function, where the fifth response message indicates a modification result of the model used by the terminal in the first session.

Optionally, the fifth request message includes at least one of the following:
an identity of the terminal;
a data network name DNN to which the first session belongs;
single network slice selection assistance information S-NSSAI of the first session;
service zone information to which the first session belongs; and
the requirement description information of the first service.

Optionally, in a case that the first network side device is the first network function, the apparatus 1000 for modifying a session further includes:
a second sending module, configured to send a sixth request message to the fourth network function according to the first request message, where the sixth request message is used for requesting modification of the data source information of the terminal in the first session; and
a third reception module, configured to receive a sixth response message from the fourth network function, where the sixth response message indicates a modification result of the data source information of the terminal in the first session.

Optionally, the sixth request message includes at least one of the following:
an identity of the terminal;
a data network name DNN to which the first session belongs;
single network slice selection assistance information S-NSSAI of the first session;
service zone information to which the first session belongs; and
the requirement description information of the first service.

Optionally, in a case that the first network side device is the first network function, the apparatus 1000 for modifying a session further includes:
a third sending module, configured to send a seventh request message to the third network function according to the first request message, where the seventh request message is used for requesting modification of the service resource used by the terminal in the first session; and
a fourth reception module, configured to receive a seventh response message from the third network function, where the seventh response message indicates a modification result of the service resource used by the terminal in the first session.

Optionally, the seventh request message includes at least one of the following:
an identity of the terminal;
a data network name DNN to which the first session belongs;
single network slice selection assistance information S-NSSAI of the first session;
service zone information to which the first session belongs;
the requirement description information of the first service;
the data source information of the first service;
a computational load of the first service; and
application server AS address information of the first service.

Optionally, in a case that the first network side device is the first network function, the apparatus 1000 for modifying a session further includes:
a fourth sending module, configured to send an eighth request message to the first resource node according to the first request message, where the eighth request message is used for requesting modification of the bearer of the first session, and the eighth request message includes the service resource configuration information; and
a fifth reception module, configured to receive an eighth response message from the first resource node, where the eighth response message indicates a modification result of the bearer of the first session.

Optionally, the apparatus 1000 for modifying a session further includes:
a third modification module, configured to modify a service policy of the first service according to the modified first session.

Optionally, the service policy includes at least one of the following:
data transmission resource information related to the data of the first service, a data forwarding rule related to the data of the first service, a data caching rule related to the data of the first service, and network context information related to the data of the first service; and a data matching policy of a terminal side for the first session, and a data sending policy of the terminal side for the first session.

Optionally, the first obtainment module 1001 is specifically configured to receive a first notification message from a third network side device. The first notification message is used for notifying the first network side device of modification of the first session.

The apparatus 1000 for modifying a session further includes:
a fifth sending module, configured to send a first response message to the third network side device. The first response message indicates a modification result of the first session.

Optionally, the apparatus 1000 for modifying a session further includes:
a sixth sending module, configured to send fifth information to a second network side device. The fifth information includes at least one of the following:
session information of the modified first session; and
a second notification message, where the second notification message is used for indicating modification of a communication bearer or a communication policy related to the first session.

Optionally, the session information includes at least one of the following:
service policy information, the service resource configuration information, the data source information, and the model information.

Optionally, the service resource configuration information includes at least one of the following:
the data source information of the first service;
the service resource information of the first service;
detection information of the first service;
a processing rule of the first service; and
the AS address information of the first service.

Optionally, the second notification message includes second indication information. The second indication information indicates modification of QoS information of the communication bearer related to the first session by the second network side device.

Optionally, the apparatus 1000 for modifying a session further includes:
a sixth reception module, configured to receive a second response message from the second network side device. The second response message is a response message to the second notification message.

Optionally, the first obtainment module 1001 is specifically configured to receive a third notification message from the second network side device. The third notification message is used for notifying the first network side device of modification of the service policy related to the first session.

The first modification module 1002 is specifically configured to modify the service policy related to the first session according to the third notification message, and modify the first session according to the modified service policy.

Optionally, the apparatus 1000 for modifying a session further includes:
a seventh sending module, configured to send a first command message to the terminal. The first command message is used for indicating modification of the first session by the terminal.

Optionally, the first command message includes at least one of the following:
the requirement description information of the first service;
a session type indication, where the session type indication indicates a type of a modified session;
the third information, where the third information is used for indicating information related to the first session;
a data transmission indication, where the data transmission indication indicates sending, by the terminal, service data associated with the requirement description information of the first service; and
a data transmission mode, where the data transmission mode indicates a transmission mode in which the terminal sends the service data associated with the requirement description information of the first service.

Optionally, the third information includes at least one of the following:
a session ID of the first session, a session type of the first session, a DNN related to the first session, a slice related to the first session, and QoS information related to the first session.

The apparatus 1000 for modifying a session according to the embodiment of the present disclosure can implement all processes implemented in the method embodiments shown in FIG. 2, and achieve same technical effects. To avoid repetition, details will not be repeated herein.

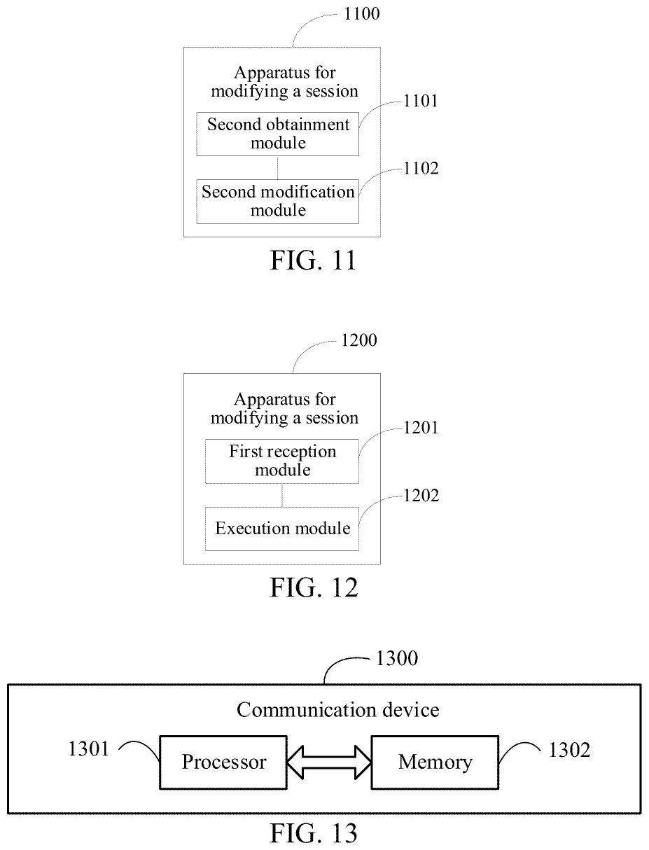

With reference to FIG. 11, the apparatus 1100 for modifying a session according to the embodiment of the present disclosure may be a second network side device, and for example, an apparatus in a network element of a communication management function. As shown in FIG. 11, the apparatus 1100 for modifying a session may include the following modules:
a second obtainment module 1101, configured to obtain fourth information; and
a second modification module 1102, configured to modify a communication bearer related to a first session according to the fourth information. The first session is used for carrying service data of a first service. The first service includes at least one of an artificial intelligence AI service and a computing service.

The fourth information includes at least one of the following:
fifth information, where the fifth information includes session information of the modified first session or a second notification message from a first network side device, and the second notification message is used for indicating modification of the communication bearer or a communication policy related to the first session; and
a fourth notification message from a third network side device, where the fourth notification message is used for notifying the second network side device of modification of the communication policy related to the first session.

Optionally, the first session satisfies at least one of the following:
the first session is a bearer between a terminal and a first resource node;
the first session has a first identity used for uniquely identifying the first session;
the first session has at least one of a dedicated data network name DNN and single network slice selection assistance information S-NSSAI; and
the first session has a quality of service QoS assurance between the terminal and the first resource node.

The first resource node includes a network function for processing the first service.

Optionally, in a case that the fourth information includes the fourth notification message, the second modification module 1102 includes:
a first modification unit, configured to modify the communication policy related to the first session according to the fourth notification message; and
a second modification unit, configured to modify the communication bearer or a communication rule related to the first session according to the modified communication policy.

Optionally, in a case that the fourth information includes the fourth notification message, the apparatus 1100 for modifying a session further includes:
an eighth sending module, configured to send a fourth response message to the third network side device, where the fourth response message indicates a modification result of the communication bearer related to the first session;
or,
a ninth sending module, configured to send a third notification message to the first network side device, where the third notification message is used for notifying the first network side device of modification of a service policy related to the first session.

Optionally, the service policy includes at least one of the following:
data transmission resource information related to the data of the first service, a data forwarding rule related to the data of the first service, a data caching rule related to the data of the first service, and network context information related to the data of the first service; and a data matching policy of a terminal side for the first session, and a data sending policy of the terminal side for the first session.

Optionally, in a case that the fourth information includes the second notification message from the first network side device, the apparatus 1100 for modifying a session further includes:
a tenth sending module, configured to send a second response message to the first network side device. The second response message is a response message to the second notification message.

Optionally, the communication policy includes at least one of the following:
data transmission resource information related to communication of the first session, a data caching rule related to the communication of the first session, a data forwarding rule related to the communication of the first session, network context information related to the communication of the first session, a data matching policy of a terminal side for the communication bearer related to the first session, and a data sending policy of the terminal side for the communication bearer related to the first session.

The apparatus 1100 for modifying a session according to the embodiment of the present disclosure can implement all processes implemented in the method embodiments shown in FIG. 8, and achieve same technical effects. To avoid repetition, details will not be repeated herein.

With reference to FIG. 12, the apparatus 1200 for modifying a session according to the embodiment of the present disclosure may be a third network side device, and for example, an apparatus in a network element of a policy charging function. As shown in FIG. 12, the apparatus 1200 for modifying a session may include the following modules:
a first reception module 1201, configured to receive a fifth notification message, where the fifth notification message is used for notifying the third network side device of modification of a service policy related to a first session, or modification of a communication policy related to the first session; and the first session is used for carrying service data of a first service, and the first service includes at least one of an artificial intelligence AI service and a computing service; and
an execution module 1202, configured to execute, according to the fifth notification message, at least one of the following steps:
a first notification message is sent to a first network side device, where the first notification message is used for notifying the first network side device of modification of the first session; and
a fourth notification message is sent to a second network side device, where the fourth notification message is used for notifying the second network side device of modification of the communication policy related to the first session.

Optionally, the first session satisfies at least one of the following:
the first session is a bearer between a terminal and a first resource node;
the first session has a first identity used for uniquely identifying the first session;
the first session has at least one of a dedicated data network name DNN and single network slice selection assistance information S-NSSAI; and
the first session has a quality of service QoS assurance between the terminal and the first resource node.

The first resource node includes a network function for processing the first service.

Optionally, the apparatus 1200 for modifying a session further includes:
a seventh reception module, configured to receive a first response message from the first network side device. The first response message indicates a modification result of the first session.

Optionally, the execution module 1202 is further configured to:
send the fourth notification message to the second network side device according to the modification result of the first session.

Optionally, the apparatus 1200 for modifying a session further includes:
an eighth reception module, configured to receive a fourth response message from the second network side device. The fourth response message indicates a modification result of a communication bearer related to the first session.

Optionally, the execution module 1202 is further configured to:
send the first notification message to the first network side device according to the modification result of the communication bearer related to the first session.

The apparatus 1200 for modifying a session according to the embodiment of the present disclosure can implement all processes implemented in the method embodiments shown in FIG. 9, and achieve same technical effects. To avoid repetition, details will not be repeated herein.

The apparatus for modifying a session in the embodiment of the present disclosure may be an electronic device, and for example, an electronic device having an operating system, or may be a component in an electronic device, and for example, an integrated circuit or a chip. The electronic device may be a network side device. For example, the network side device may include, but is not limited to, the listed types of the core network device, and is not specifically limited by the embodiments of the present disclosure.

As shown in FIG. 13, an embodiment of the present disclosure further provides a communication device 1300. The communication device includes a processor 1301 and a memory 1302. The memory 1302 stores a program or an instruction runnable on the processor 1301. For example, in a case that the communication device 1300 is a first network side device, when the program or the instruction is executed by the processor 1301, all steps of the embodiment of the method for modifying a session as shown in FIG. 2 are implemented, and same technical effects can be achieved. In a case that the communication device 1300 is a second network side device, when the program or the instruction is executed by the processor 1301, all steps of the embodiment of the method for modifying a session as shown in FIG. 8 are implemented. In a case that the communication device 1300 is a third network side device, when the program or the instruction is executed by the processor 1301, all steps of the embodiment of the method for modifying a session as shown in FIG. 9 are implemented, and same technical effects can be achieved. To avoid repetition, details will not be repeated herein.

An embodiment of the present disclosure further provides a network side device. The network side device includes a processor and a communication interface. The communication interface is coupled to the processor. The processor is configured to run a program or an instruction, such that steps of the method embodiment shown in FIG. 2, FIG. 8, or FIG. 9 are implemented. The embodiment of the network side device corresponds to the method embodiment of the network side device. Various implementation processes and implementations of the method embodiment may be all applied to the embodiment of the network side device and can achieve same technical effects.

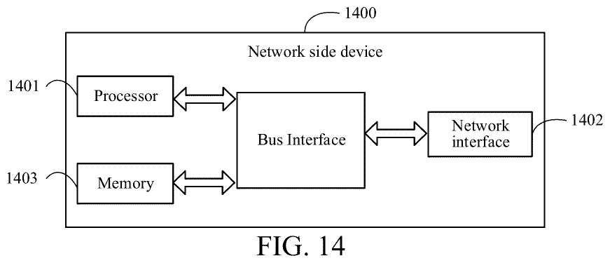

Specifically, an embodiment of the present disclosure further provides a network side device. As shown in FIG. 14, the network side device 1400 includes a processor 1401, a network interface 1402, and a memory 1403. The network interface 1402 may be, for example, a common public radio interface (CPRI).

Specifically, the network side device 1400 of the embodiment of the present disclosure further includes an instruction or a program stored in the memory 1403 and runnable on the processor 1401. The processor 1401 invokes the instruction or the program in the memory 1403 to execute the method executed by each module as shown in FIG. 10, FIG. 11, or FIG. 12, and achieves same technical effects. To avoid repetition, details will not be repeated herein.

An embodiment of the present disclosure further provides a readable storage medium. The readable storage medium stores a program or an instruction. When the program or the instruction is executed by a processor, all processes of the method embodiment shown in FIG. 2, FIG. 8, or FIG. 9 are implemented, and same technical effects can be achieved. To avoid repetition, details will not be repeated herein.

The processor is a processor in the terminal of the embodiment. The readable storage medium includes a computer readable storage medium, such as a computer read-only memory ROM, a random access memory RAM, a magnetic disk, or an optical disk. In some examples, the readable storage medium may be a non-transitory readable storage medium.

An embodiment of the present disclosure further provides a chip. The chip includes a processor and a communication interface. The communication interface is coupled to the processor. The processor is configured to run a program or an instruction, such that all processes of the method embodiment shown in FIG. 2, FIG. 8, or FIG. 9 are implemented, and same technical effects can be achieved. To avoid repetition, details will not be repeated herein.

It should be understood that the chip mentioned in the embodiment of the present disclosure may alternatively be referred to as a system on a chip, a system chip, a chip system, a system-on-chip, etc.

An embodiment of the present disclosure further provides a computer program/program product. The computer program/program product is stored in a storage medium. The computer program/program product is executed by at least one processor, such that all processes of the method embodiment shown in FIG. 2, FIG. 8, or FIG. 9 are implemented, and same technical effects can be achieved. To avoid repetition, details will not be repeated herein.

An embodiment of the present disclosure further provides a communication system. The communication system includes a first network side device, or includes a first network side device and at least one of a second network side device and a third network side device. The first network side device may be configured to execute steps of the method embodiment shown in FIG. 2. The second network side device may be configured to execute steps of the method embodiment shown in FIG. 8. The third network side device may be configured to execute steps of the method embodiment shown in FIG. 9.

A first implementation uses a case that the first network side device is at least one of an AI model management function, an AI resource management function, an AI resource node, and a data plane management function as an example. As shown in FIG. 3, at least one of the AI model management function, the AI resource management function, the AI resource node and the data plane management function may perform modification related to an AI service on an AI session based on its own requirement.

A second implementation uses a case that the first network side device is the AI model management function and the second network side device is a communication management function as an example. As shown in FIG. 4, the AI model management function may be based on a first request message from a first communication device (such as an OTT server or an AF), and request AI service-related modification of the AI session by at least one of the AI model management function, the AI resource management function, the AI resource node, and the data plane management function according to the first request message. In addition, after the AI session is modified, fifth information may further be sent to the communication management function according to related information of the modified AI session. The fifth information includes at least one of the following:
session information of the modified first session; and
a second notification message, where the second notification message is used for indicating modification of a communication bearer or a communication policy related to the first session.

In this way, the communication management function may modify a communication bearer related to the AI session based on the fifth information.

A third implementation uses a case that the first network side device is the AI model management function, the second network side device is the communication management function, and the third network side device is a policy charging function as an example. As shown in FIG. 5, an NEF authenticates the first request message from the first communication device (such as an OTT server or an AF) and stores a modification parameter in the first request message in a UDR. The UDR may notify the policy charging function of updating of policy information according to the stored information. The policy information includes an AI-related policy (i.e. an AI policy) and a communication-related policy (i.e. a communication policy).

In some implementations, the policy charging function may notify an AI service management function of corresponding modification of the AI session and notify the communication management function of corresponding modification of the communication bearer according to the updated policy information.

A fourth implementation uses a case that the first network side device is the AI model management function, the second network side device is the communication management function, and the third network side device is the policy charging function as an example. As shown in FIG. 6, the NEF authenticates the first request message from the first communication device (such as an OTT server or an AF) and stores the modification parameter in the first request message in the UDR. The UDR may notify the policy charging function of updating of the policy information according to the stored information. The policy information includes the AI-related policy (i.e. an AI policy) and the communication-related policy (i.e. a communication policy).

Then, the policy charging function may notify the AI service management function of corresponding modification of the AI session according to updated AI policy information, and trigger modification of the communication bearer related to the AI session according to a modification result of the AI session. For example, the AI service management function feeds back the modification result of the AI session to the policy charging function, and the policy charging function sends a second modification notification message to the communication management function according to the modification result of the AI session, to notify the communication management function of modification of the communication bearer. Or, the AI service management function sends the second modification notification message to the communication management function according to the modification result of the AI session, to notify the communication management function of modification of the communication bearer.

A fifth implementation uses a case that the first network side device is the AI model management function, the second network side device is the communication management function, and the third network side device is the policy charging function as an example. As shown in FIG. 7, the NEF authenticates the first request message from the first communication device (such as an OTT server or an AF) and stores a modification parameter in the first request message in the UDR. The UDR may notify the policy charging function of updating of the policy information according to the stored information. The policy information includes the AI-related policy (i.e. an AI policy) and the communication-related policy (i.e. a communication policy).

Then, the policy charging function may notify the communication management function of corresponding modification of the communication bearer according to updated communication policy information, and trigger modification of the AI session related to the communication bearer according to the modification result of the communication bearer. For example, the communication management function feeds back the modification result of the communication bearer to the policy charging function, and the policy charging function sends a first modification notification message to the AI service management function according to the modification result of the communication bearer, to notify the AI service management function of modification of the AI session. Or, the communication management function sends the first modification notification message to the AI service management function according to the modification result of the communication bearer, to notify the AI service management function of modification of the AI session.

It should be noted that terms “include”, “comprise”, “involve”, or their any other variations herein are intended to cover non-exclusive inclusions, such that a process, a method, an article, or an apparatus including a series of elements not only includes those elements, but also includes other elements that are not explicitly listed, or includes inherent elements of the process, the method, the article, or the apparatus. Without more limitations, the elements defined by the sentence “include a . . . ” or “comprise a . . . ” do not exclude existence of other same elements in the process, the method, the article, or the apparatus including the elements. In addition, it should be noted that a range of the method and the apparatus in an implementation of the present disclosure is not limited to execution of functions in order shown or discussed, and may further include execution of functions involved in a substantially simultaneous manner or in reverse order. For example, the method described may be executed in order different from that described, and various steps may be added, omitted, or combined. Moreover, the features described with reference to some examples may be combined in other examples.

From the description of the above implementations, those skilled in the art may clearly understand that the method of the embodiment may be implemented through a computer software product plus a necessary general-purpose hardware platform, or may be implemented through hardware. The computer software product is stored in a storage medium (such as a read-only memory (ROM), a random access memory (RAM), a magnetic disk, and an optical disk), and includes a plurality of instructions, to enable the terminal or the network side device to execute the method according to all the embodiments of the present disclosure.

The embodiments of the present disclosure are described above with reference to the accompanying drawings, and the present disclosure is not limited to specific implementations. The above specific implementations are merely illustrative rather than limitative. Inspired by the present disclosure, those of ordinary skill in the art may still make implementations in many forms without departing from the essence of the present disclosure and the protection scope of the claims. The implementations all fall within the protection scope of the present disclosure.

What is claimed is:

1. A method for modifying a session, comprising:
obtaining first information by a first network side device; and
modifying, by the first network side device, a first session according to the first information, wherein the first session is used for carrying service data of a first service of a terminal, and the first service comprises at least one of an artificial intelligence (AI) service or a computing service, wherein
the first information comprises at least one of the following:
requirement description information of the first service;
service resource configuration information; or
a first request message, wherein the first request message is used for requesting modification of the first session.

2. The method according to claim 1, wherein the first session satisfies at least one of the following:
the first session is a bearer between the terminal and a first resource node;
the first session has a first identity used for uniquely identifying the first session;
the first session has at least one of a dedicated data network name (DNN) and single network slice selection assistance information (S-NSSAI); or
the first session has a quality of service (QoS) assurance between the terminal and the first resource node, wherein
the first resource node comprises a network function for processing the first service.

3. The method according to claim 1, wherein the first network side device comprises at least one of the following:
a first network function, wherein the first network function is used for managing the first service;
a second network function, wherein the second network function is used for managing a model;
a third network function, wherein the third network function is used for managing a service resource;
the first resource node; or
a fourth network function, wherein the fourth network function is used for executing data management.

4. The method according to claim 1, wherein the modifying, by the first network side device, a first session according to the first information comprises:
modifying, by the first network side device according to the first information, at least one of the following of the first session:
a transmission mode of data of the first service;
a service resource of the first service;
a data source of the first service;
a model of the first service; or
a bearer of the first session.

5. The method according to claim 1, wherein in a case that the first information comprises the first request message, the obtaining first information by a first network side device comprises:
receiving, by the first network side device, the first request message from a first communication device.

6. The method according to claim 1, wherein the first request message comprises at least one of the following:
the requirement description information of the first service;
second information, wherein the second information comprises information of a communication resource related to the first session; or
third information, wherein the third information comprises information of the first session.

7. The method according to claim 1, wherein the requirement description information of the first service comprises at least one of the following:
an identity of the first service;
a quality of experience (QoE) requirement of the first service;
QoS information of the first service;
model information of the first service; or
first indication information, wherein the first indication information is used for indicating whether interaction with a target network function is needed.

8. The method according to claim 7, wherein the modifying, by the first network side device, a first session according to the first information comprises:
modifying, by the first network side device, a model used by the terminal in the first session in a case that it is determined that the first information satisfies a first condition, wherein
the first condition comprises at least one of the following:
the requirement description information of the first service comprises the model information;
the requirement description information of the first service comprises the QoS information of the first service, and the QoS information of the first service does not match the model information used by the terminal in the first session;
the third information comprises QoS information related to the first session, and the QoS information related to the first session does not match the model information used by the terminal in the first session; or
the first indication information indicates that interaction with the second network function is needed;
or,
wherein the modifying, by the first network side device, a first session according to the first information comprises:
triggering, by the first network side device, modification of a data source of the terminal in the first session in a case that it is determined that the first information satisfies a second condition, wherein
the second condition comprises at least one of the following:
the first request message carries data source information;
the requirement description information of the first service comprises the model information, and the model information does not match the data source information used by the terminal in the first session;
the requirement description information of the first service comprises the QoS information of the first service, and the QoS information of the first service does not match the data source information used by the terminal in the first session;
the third information comprises QoS information related to the first session, and the QoS information related to the first session does not match the data source information used by the terminal in the first session; or
the first indication information indicates that interaction with the fourth network function is needed;
or,
wherein the modifying, by the first network side device, a first session according to the first information comprises:
modifying, by the first network side device, a service resource used by the terminal in the first session in a case that it is determined that the first information satisfies a third condition, wherein
the third condition comprises at least one of the following:
the requirement description information of the first service comprises the model information, and the model information does not match service resource information used by the terminal in the first session;
the requirement description information of the first service comprises the QoS information of the first service, and the QoS information of the first service does not match the service resource information used by the terminal in the first session;
the third information comprises QoS information related to the first session, and the QoS information related to the first session does not match the service resource information used by the terminal in the first session; or
the first indication information indicates that interaction with the third network function is needed.

9. The method according to claim 5, wherein in a case that the first network side device is the first network function, the method further comprises:
sending, by the first network side device, a fifth request message to the second network function according to the first request message, wherein the fifth request message is used for requesting modification of the model used by the terminal in the first session; and
receiving, by the first network side device, a fifth response message from the second network function, wherein the fifth response message indicates a modification result of the model used by the terminal in the first session.

10. The method according to claim 9, wherein the fifth request message comprises at least one of the following:
an identity of the terminal;
a data network name (DNN) to which the first session belongs;
single network slice selection assistance information (S-NSSAI) of the first session;
service zone information to which the first session belongs; or
the requirement description information of the first service.

11. The method according to claim 5, wherein in a case that the first network side device is the first network function, the method further comprises:
sending, by the first network side device, a sixth request message to the fourth network function according to the first request message, wherein the sixth request message is used for requesting modification of the data source information of the terminal in the first session; and
receiving, by the first network side device, a sixth response message from the fourth network function, wherein the sixth response message indicates a modification result of the data source information of the terminal in the first session.

12. The method according to claim 11, wherein the sixth request message comprises at least one of the following:
an identity of the terminal;
a data network name (DNN) to which the first session belongs;
single network slice selection assistance information (S-NSSAI) of the first session;
service zone information to which the first session belongs; or
the requirement description information of the first service.

13. The method according to claim 5, wherein in a case that the first network side device is the first network function, the method further comprises:
sending, by the first network side device, a seventh request message to the third network function according to the first request message, wherein the seventh request message is used for requesting modification of the service resource used by the terminal in the first session; and
receiving, by the first network side device, a seventh response message from the third network function, wherein the seventh response message indicates a modification result of the service resource used by the terminal in the first session.

14. The method according to claim 13, wherein the seventh request message comprises at least one of the following:
an identity of the terminal;
a data network name (DNN) to which the first session belongs;
single network slice selection assistance information (S-NSSAI) of the first session;
service zone information to which the first session belongs;
the requirement description information of the first service;
data source information of the first service;
a computational load of the first service; or
application server (AS) address information of the first service.

15. The method according to claim 5, wherein in a case that the first network side device is the first network function, the method further comprises:
sending, by the first network side device, an eighth request message to the first resource node according to the first request message, wherein the eighth request message is used for requesting modification of the bearer of the first session, and the eighth request message comprises the service resource configuration information; and
receiving, by the first network side device, an eighth response message from the first resource node, wherein the eighth response message indicates a modification result of the bearer of the first session.

16. A method for modifying a session, comprising:
obtaining fourth information by a second network side device; and
modifying, by the second network side device, a communication bearer related to a first session according to the fourth information, wherein the first session is used for carrying service data of a first service, and the first service comprises at least one of an artificial intelligence (AI) service or a computing service, wherein
the fourth information comprises at least one of the following:
fifth information, wherein the fifth information comprises session information of the modified first session or a second notification message from a first network side device, and the second notification message is used for indicating modification of a communication bearer or a communication policy related to the first session; or
a fourth notification message from a third network side device, wherein the fourth notification message is used for notifying the second network side device of modification of the communication policy related to the first session.

17. A method for modifying a session, comprising:
receiving a fifth notification message by a third network side device, wherein the fifth notification message is used for notifying the third network side device of modification of a service policy related to a first session or modification of a communication policy related to the first session; and the first session is used for carrying service data of a first service, and the first service comprises at least one of an artificial intelligence (AI) service or a computing service; and
executing, by the third network side device according to the fifth notification message, at least one of the following steps:
sending a first notification message to a first network side device, wherein the first notification message is used for notifying the first network side device of modification of the first session; or
sending a fourth notification message to a second network side device, wherein the fourth notification message is used for notifying the second network side device of modification of the communication policy related to the first session.

18. A communication device, comprising a processor and a memory, wherein the memory stores a program or an instruction runnable on the processor, and when the program or the instruction is executed by the processor, steps of the method for modifying a session according to claim 1 are implemented.

19. A communication device, comprising a processor and a memory, wherein the memory stores a program or an instruction runnable on the processor, and when the program or the instruction is executed by the processor, steps of the method for modifying a session according to claim 16 are implemented.

20. A communication device, comprising a processor and a memory, wherein the memory stores a program or an instruction runnable on the processor, and when the program or the instruction is executed by the processor, steps of the method for modifying a session according to claim 17 are implemented.
